(19) United States
(12) Patent Application Publication
(10) Pub. No.: US 2018/0075527 A1
(43) Pub. Date: Mar. 15, 2018

(54) CREDIT SCORE PLATFORM

(71) Applicant: ROYAL BANK OF CANADA, Montreal (CA)

(72) Inventors: Gaurav NAGLA, Oakville (CA); Archana NAGLA, Toronto (CA)

(21) Appl. No.: 15/704,136

(22) Filed: Sep. 14, 2017

Related U.S. Application Data
(60) Provisional application No. 62/394,413, filed on Sep. 14, 2016.

(51) Int. Cl. G06Q 40/02; G06F 21/64; G06F 21/62

(52) U.S. Cl. CPC G06Q 40/025; G06F 21/6218; G06F 21/64

(57) ABSTRACT

Embodiments described herein provide a credit score platform using blockchain technology. Credit records are recorded using blocks linked by identification data. The credit record stores historical and predictive information about borrowers used to compute credit ratings.

### CROSS REFERENCE TO RELATED APPLICATION

This application claims the benefit of and priority to U.S. Provisional Application No. 62/394,413 filed Sep. 14, 2016, the entire contents of which are hereby incorporated by reference.

### FIELD

Embodiments described herein generally relate to the field of distributed storage platforms, distributed ledgers and credit scoring.

### INTRODUCTION

A credit score is a value that represents the creditworthiness of a person, business, organization or other entity. A credit score is calculated based on credit report information typically sourced from credit bureaus. Over the life of an individual there may be different events that can be relevant (directly or indirectly) to the creditworthiness of a person, business, organization or other entity.

Creditors or lenders use credit scores to evaluate the potential risk posed by lending money to a borrower. Lenders use credit scores to determine whether a borrower qualifies for a loan, at what interest rate, and what credit limits. Credit scoring is often conducted prior to authorizing access or granting credit.

Credit scoring is not limited to lenders. Other organizations, such as mobile phone companies, retailers, insurance companies, landlords, accommodations operators, and government departments can also consider credit scores prior to conducting transactions.

Credit scores generated by conventional techniques may be incomplete and unclear. Traditionally only a small number of credit bureaus generate credit scores using data from limited data sources. It can be difficult to confirm the veracity and integrity of the data sources. The consumer may not understand how their credit score is generated. The consumer might not be notified when data is submitted that impacts their credit score.

A distributed ledger platform is a decentralized distributed database platform. A blockchain has data structure blocks that represent transactions, data records or applications (e.g. smart contracts). An example distributed ledger platform is a blockchain platform.

### SUMMARY

In accordance with an aspect there is provided a system for credit and digital identity records. The system can include a distributed ledger of a plurality of nodes. Each node includes at least a computing device, and the distributed ledger has a plurality of blocks, each block comprising identification data linked to a set of identifiers for an individual, transaction data, a timestamp indicating when the block was created, and a hash reference for the distributed ledger. System can include a credit history application configured to: register an individual corresponding to a first set of identifiers; record a set of blocks of the plurality blocks on the distributed ledger, each block of the set of blocks having an identifier of the first set of identifiers, the set of blocks including an initial block for the individual registration, the initial block comprising attributes for the individual, and permission attributes; receive notification of a credit event for the individual, the notification having an identifier of the first set of identifiers; record an additional block on the distributed ledger, the additional block having the identifier of the first set of identifiers and credit event attributes; generate the credit history record using the first set of identifiers, the credit history record comprising a credit score, the set of blocks and the additional block, each block of the credit history records having an identifier of the first set of identifiers; and transmit the credit history record to an interface, enterprise system or external system.

In some embodiments, the system has a digital identity application configured to: assign a universal identifier to the individual; record an additional set of blocks of the plurality blocks on the distributed ledger, each block of the additional set of blocks comprising the universal identifier and a different identifier of the first set of identifiers; and generate a digital identity for the individual using the additional set of blocks and the universal identifier; wherein the credit history application is configured to generate the credit history record using the digital identity to construct the set of identifiers.

In some embodiments, the credit history application is configured to calculate a change in the credit score based on the credit event.

In some embodiments, the credit history application is configured to determine one or more credit actions in response to the credit event using a smart contract related to the credit event and the individual, the smart contract including an electronic signature and transaction terms.

In some embodiments, the credit history application is configured to generate a notification or alert relating to the credit event to provide the individual organization with notification that a credit event has been received by the system. This can provide transparency. In some embodiments, the notification for the credit event indicates a violation of the smart contract.

In some embodiments, the system has a smart contract middleware application configured to detect violation of a term of a smart contract linked to the identifier as the credit event and trigger the notification of the credit event in response, the smart contract including an electronic signature and transaction terms.

In some embodiments, the system has a security unit configured to receive a registration request to register the individual from a registration system, and verify the registration system prior to registration of the individual.

In some embodiments, the system has a security unit configured to verify the interface, the enterprise system or the external system using the permission attributes before providing access to the credit history record.

In some embodiments, the system has a security unit configured to verify credit event for the individual prior to recording the additional block.

In some embodiments, the system has a credit marketplace engine configured to generate a listing of loan offers for the individual based on the credit history record, each loan offer indicating a creditor and loan terms, receive a selected loan offer indicating a selected creditor and selected loan terms, generate a smart contract with the selected loan terms, and record a new block on the distributed ledger, the new block having the smart contract, the identifier and the selected creditor, the smart contract being linked to an identifier of the set of identifiers and the selected creditor, the smart contract having an electronic signature and transaction terms.

In some embodiments, the notification for the credit event indicates a violation of the smart contract.

In some embodiments, the system has a credit marketplace engine configured to receive a loan request for the individual and generate a listing of loan offers for the individual based on the credit history record, each loan offer indicating a creditor and loan terms.

In some embodiments, the system has a creditor and debtor application to transmit the credit history record to a creditor, receive a bid for a loan for the individual from the creditor, transmit a notification of the bid to the individual; and receive an acceptance of the bid from the individual, the bid indicating transaction terms.

In some embodiments, the system has a smart contract middleware application configured to generate a smart contract, and record a new block on the distributed ledger, the new block having the smart contract, the smart contract including an electronic debtor signature, an electronic creditor signature, the transaction terms, and an identifier of the set of identifiers.

In some embodiments, the creditor and debtor application is configured to calculate the transaction terms based on the credit history record.

In some embodiments, the system has an integration middleware layer configured to: determine that the transaction terms are satisfied; trigger notification of the credit event based on the determination; and record another block on the distributed ledger for the loan, the other block comprising the identifier of the set of identifiers and creditor identification.

In some embodiments, the system has an integration middleware layer configured to: receive payment notification for the loan; trigger notification of the credit event based on the payment notification.

In some embodiments, the system has a security unit configured to verify the creditor by receiving creditor credentials, and comparing the creditor credentials to the permission attributes prior to providing access to the credit history record.

In some embodiments, the system has an integration middleware layer configured to receive a debtor registration request for the individual, the debtor registration request indicating individual; verify the debtor registration request; trigger generation of the universal identifier by the digital identity application, and generate an initial block for the credit history record, the initial block indicating the universal identifier and debtor attributes.

In some embodiments, the creditor and debtor application is configured to receive a creditor registration request for the creditor, verify the creditor registration request, and generate an additional block for the credit history record, the additional block comprising creditor attributes, the transaction terms, and an identifier of the set of identifiers.

In some embodiments, the credit marketplace engine is configured to receive a loan search request with a set of parameters and identify the listing of loan offers based on the loan search request by comparing the set of parameters to loan data.

In some embodiments, the system has an alert and notification unit configured to generate a credit alert for the individual indicating the credit event and transmit the credit alert to the individual using the first set of identifiers. The credit alert can provide a notification to an individual that a cretin event has been received by system. The individual may want to dispute the credit event and may emit a dispute request to system. The credit alert can also indicate the source of the credit event.

In some embodiments, the credit history application is configured to determine an impact of the credit event on the credit history record of the individual.

In some embodiments, the credit history application is configured to compute a credit score based on the credit history record of the individual and generate a credit score notification indicating the credit score and the credit event.

In another aspect there is provided a system for credit and digital identity records with a distributed ledger of a plurality of nodes, each node including at least a computing device, and the distributed ledger having a plurality of blocks, each block comprising identification data linked to a set of identifiers for an individual, transaction data, a timestamp indicating when the block was created, and a hash reference for the distributed ledger. The system has a credit marketplace engine configured to generate a listing of loan offers for an individual based on a credit history record comprising a set of blocks of the plurality blocks, each block of the set of blocks having an identifier of the set of identifiers, each loan offer indicating a creditor and loan terms. The system has a creditor and debtor application configured to: receive a selected loan offer indicating a selected creditor and selected loan terms; transmit a notification of the selected loan offer to the creditor; receive an acceptance of the selected loan offer from the creditor; a smart contracts middleware layer configured to generate a smart contract with the selected loan terms, the smart contract being linked to an identifier of the set of identifiers and the selected creditor, the smart contract having an electronic signature and transaction terms. The system has an integration middleware layer configured to record a new block on the distributed ledger, the new block having the smart contract, the identifier and the selected creditor.

In another aspect, there is provided computer-implemented system for maintaining credit and digital identity records. The system has a plurality of nodes, each node including at least a computing device and being configured to maintain and update a distributed ledger having a plurality of blocks; each block comprising (i) identification data (ii) transaction data, (iii) a timestamp indicating when the block was created, (iv) a hash reference for the blockchain. The system has at least one processor configured to generate a credit record comprising a first set of blocks of the plurality blocks, each block of the first set of blocks comprising identification that maps to a digital identity record, the digital identity record comprising a second set of blocks of the plurality blocks, each block of the second set of blocks linked to a set of identifiers for an individual.

In some embodiments, a block of the set of blocks is an initial block for the credit record, the initial block comprising (i) registration data, (ii) ownership attributes, and (iii) permission attributes for the credit record.

In some embodiments, the permission attributes authorize a node of the plurality of nodes to (i) create a new block for insertion into the set of blocks of the credit record, (ii) update an existing block in the set of blocks of the credit record, (iii) delete or mark the existing block in the set of blocks of the credit record, (iv) retrieve the identity and transaction data from one or more blocks in the set of blocks of the credit record.

In some embodiments, the identity and transaction data includes data extracted from a machine-readable contract provided in a domain specific language format.

In some embodiments, a node of the plurality of nodes is one or more computing devices associated with a financial or lending institution.

In some embodiments, the plurality of nodes includes one or more anonymous computing devices.

In some embodiments, the distributed ledger is publicly accessible.

In some embodiments, the distributed ledger is accessible only by computing devices associated with the plurality of nodes.

In some embodiments, the plurality of nodes is configured for validating or verifying a new block presented by one of the plurality of nodes for insertion into the blockchain.

In some embodiments, the system has a machine learning processor to detect and predict impact to the credit record and trigger generation and transmission of a notification upon the detection and prediction of the impact.

In some embodiments, the system has an interface utility to generate an on demand real time visualization of the credit record.

In some embodiments, the system has an interface utility to generate notifications for an update to the credit record.

In another aspect there is provided a tool for use with the system with features described herein. The tool is configured for conducting automated confirmation of information stored on one or more records using information extracted from the distributed ledger.

In accordance with an aspect, there is provided a computer-implemented system for maintaining credit and digital identity records and generating visualizations and notifications for the credit and digital identify records. The system involves a plurality of nodes, each node including at least a computing device and being configured to maintain and update a distributed ledger having a plurality of blocks arranged in a blockchain; each block comprising (i) identification data (ii) transaction data, (iii) a timestamp indicating when the block was created, (iv) a hash reference for the blockchain. A credit record has a first set of blocks of the plurality blocks, each block of the first set of blocks comprising identification that maps to a digital identity record, the digital identity record having a second set of blocks of the plurality blocks.

In some embodiments, a block of the set of blocks is an initial block for the credit record, the initial block having (i) registration data, (ii) ownership attributes, and (iii) permission attributes for the credit record.

In some embodiments, the permission attributes authorize a node of the plurality of nodes to (i) create a new block for insertion into the set of blocks of the credit record, (ii) update an existing block in the set of blocks of the credit record, (iii) delete or mark the existing block in the set of blocks of the credit record, (iv) retrieve the identity and transaction data from one or more blocks in the set of blocks of the credit record.

In some embodiments, the identity and transaction data includes data extracted from a machine-readable contract provided in a domain specific language format.

In some embodiments, a node of the plurality of nodes is one or more computing devices associated with a financial or lending institution.

In some embodiments, the plurality of nodes includes one or more anonymous computing devices.

In some embodiments, the distributed ledger is publicly accessible.

In some embodiments, the distributed ledger is accessible only by computing devices associated with the plurality of nodes.

In some embodiments, the plurality of nodes is configured for validating or verifying a new block presented by one of the plurality of nodes for insertion into the blockchain.

In some embodiments, the system further involves a machine learning processor to detect and predict impact to the credit record and trigger generation and transmission of a notification upon the detection and prediction of the impact.

In some embodiments, the system further involves an interface utility to generate an on demand real time visualization of the credit record.

In some embodiments, the system further involves an interface utility to generate notifications for an update to the credit record.

In some embodiments, there is provided a tool for use with the system, the tool being configured for conducting automated confirmation or verification of information stored on one or more records using information extracted from the distributed ledger.

Many further features and combinations thereof concerning embodiments described herein will appear to those skilled in the art following a reading of the instant disclosure.

### DESCRIPTION OF THE FIGURES

Embodiments will now be described, by way of example only, with reference to the attached figures, wherein in the figures:

FIG. 1 is a block diagram illustrating blockchain topology;

FIG. 2 is a sample blockchain;

FIG. 3 is a schematic diagram of an electronic credit score platform according to some embodiments;

FIG. 4 is a schematic diagram of another electronic credit score platform according to some embodiments;

FIG. 5 is a schematic diagram of another electronic credit score platform according to some embodiments;

FIG. 6 is a diagram of entities interacting with a set of identifiers for an individual;

FIGS. 7A, 7B, 7C, 7D are a system context diagram according to some embodiments;

FIG. 8 is a workflow diagram of smart contract for a loan marketplace; and

FIGS. 9A and 9B are data model diagrams according to some embodiments.

### DETAILED DESCRIPTION

Embodiments, platforms, methods, devices, and computer-readable media described herein provide a credit score platform to generate secure digital identity records and credit scores using disparate data sources, distributed ledgers or blockchains. The digital identity records include a set of identifiers and data regarding social, credit and transaction history for an individual, business, organization or other entity. Each unique digital identity record is associated with an individual, business, organization or other entity. The digital identity record includes or links to data used to calculate credit score for an individual, business, organization or other entity. The digital identity record is a collection of blocks from one or more blockchains. The blocks forming the digital identify record are linked by one or more identifiers of the set of identifiers for the respective digital identity record. For simplicity an individual, business, organization or other entity may be referred to as a debtor or borrower, which includes a potential debtor or borrower.

The digital identity record for the credit score includes a set of identifiers to identify an individual. An identifier can be one or more characteristics of a borrower which cannot be changed. Examples of characteristics for a borrower that is an individual include: date of birth, biometric data (e.g. DNA and genetic analysis, heartbeat signature), passport info, social security or insurance number, health care identifier, and so on. An individual can have identifiers for different countries and the set of identifiers can connect the identifiers for the different countries to provide a global or multinational digital identity record. The set of identifiers may be linked to a universal identifier generated by embodiments described herein and assigned to the individual. The universal identifier can be unique to the individual.

A credit score is calculated for borrower using disparate data sources to determine credit behaviours and attitudes as an assessment of the creditworthiness of the borrower.

Example data sources include retailer data that can be processed to identify spending patterns, social network data to identify association with peer groups, insurance data to identify insurance claims, law enforcement data to identify traffic and legal violations, and so on.

The disparate data sources provide data to credit score platform to generate blocks of data elements that are stored on one or more blockchains. Each block is linked to a digital identity record. Different parties can provide data to generate blocks of data elements. The individual associated with a digital identify record can receive notification of updates to blocks that make up their digital identify record. Updates to the digital identify record can occur in real-time or near real-time.

Data records from different data sources can be linked to different identifiers of the set of identifiers. Accordingly, the set of identifiers can be used an index to generate a credit score and credit history record for the individual. For example, a phone bill may be linked to a name, address, phone number and credit card. These may be used as identifiers. As another example, a loan may be link to the social insurance number. This may be another identifier. As a further example, a rental agreement may be linked to a passport number and name. These may be used as identifiers. Another example is a social network account which may be linked to a name, address and email address. A universal identifier linked to the individual can be used to connect the different identifiers to generate a set of identifiers for the individual. Events related to the phone bill, loan, rental agreement and social network account may be captured and recorded by embodiments described herein for use in generating a credit history and credit score.

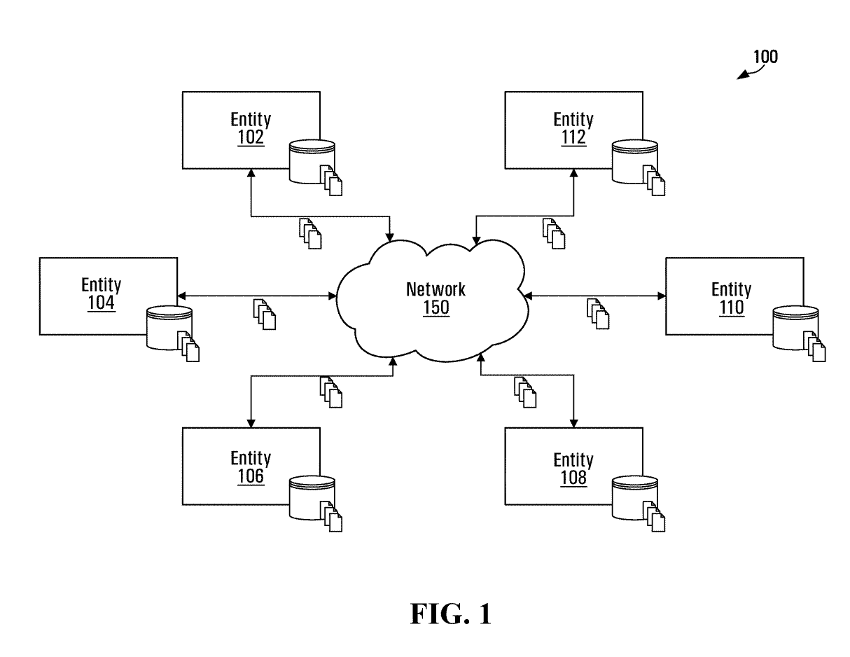

FIG. 1 is a block diagram illustrating a blockchain topology 100 that provides distributed ledgers (e.g. blockchains) of blocks across one or more entities 102, 104, 106, 108, 110, and 112, according to some embodiments. The blocks store data elements for digital identify records used to calculate credit scores. Entities 102, 104, 106, 108, 110, and 112 may include, for example, credit bureaus, financial institutions, insurance companies, parties to a transaction, individual computing devices, shared computing resources, smart devices (e.g., smartwatches, tablets, smartphones), etc. The entities may store the distributed ledgers on computing systems which may be utilized in maintaining and/or updating the ledgers. Each entity 102, 104, 106, 108, 110, and 112 may be configured for storing a version of the distributed ledger, and the distributed ledger may be updated from time to time with modifications to the ledger and/or ledger entries, such as insertion of a ledger entry or an update of a ledger entry. The blockchain topology 100 may be adapted such that where issues arise with the distributed ledger (e.g., hash collisions, insertions at the same time, corrupted ledgers/ledger entries), the issues are automatically resolved based at least on issue resolution logic. For example, such logic may be distributed among each of the entities 102, 104, 106, 108, 110, and 112 and/or their computing systems. In some embodiments, issues may arise that can cause a distributed ledger to “fork” and/or spawn another instance, for example, where a collision cannot be automatically resolved.

In some embodiments, the entities 102, 104, 106, 108, 110, and 112 include at least a decentralized set of computing devices and may even include personal or business computing devices, etc. For example, a ledger may be stored on a large number of publicly available devices, each acting as a “node” for storing a copy of the ledger (e.g., being collaboratively maintained by anonymous peers on a network). In some embodiments, the ledger is only stored and maintained on a set of trusted “nodes”, such as the computing systems of authorized users. In some embodiments, a combination and/or a “mix” of both trusted nodes and public nodes may be utilized, with the same and/or different rules being applied to activities performed at each (e.g., a different validation process may be used for untrusted nodes, or simply untrusted nodes may be unable to perform certain activities). In some embodiments, there may be different levels of nodes with differing characteristics and applied business logic.

The ledgers, ledger entries, and/or information stored on the ledger entries may be used for digital identify records and credit score calculations. Digital identify records may include information regarding transactions involving borrowers, education and employment history, spending patterns, social network peers, household data, automated “smart contracts”; documents relating to creditworthiness of borrowers, and so on. Further, the ledger and ledger entries may utilize encryption technology to facilitate and/or validate digital signatures, for example, facilitating multi-signature documentation, ensuring the integrity of digital identify records, and so on. Credit score calculations may involve different metrics and different weightings for aggregating data elements. Ledger entries and blocks can include such data for automatic credit score calculations.

In some embodiments, the ledger is publicly accessible so that different parties can create blocks of data elements for digital identify records and credit score calculations. In some embodiments, the ledger is only accessible to select, authorized entities having the appropriate permissions. Where the ledger is publicly accessible, the ledger may adapted to only store information incidental to a transaction or a document relating to a borrower, and may be adapted such that identifiable information is removed but validation information is maintained (e.g., storing a hash value computed from the underlying information such that a ledger entry can be utilized to validate a specific financial system entry that is held as part of an organization's business records in relation to a contractual obligation). The digital identify records and credit score information stored on the ledger may be encrypted, redacted, compressed, transformed (e.g., through a one-way transformation or a reversible transformation), etc.

Each of the one or more entities 102, 104, 106, 108, 110, and 112 may have, at various times, versions of the ledger, and the ledger may be maintained through the propagation of entries and/or updates that may be copied across ledgers. Ledger entries may contain elements of information (e.g., transaction records, document content, contract clauses, version information). There may be various rules and/or logic involved in activities relating to the ledger entries (e.g., creating, updating, validating, deleting), for example, a supermajority or a unanimous consent between entities may be enforced as a condition to an activity relating to an entry. In some embodiments, distributed ledgers are utilized and the ledger entries are adapted to have various linkages to one another such that the integrity of the ledger entries can be reinforced and/or validated. For example, the linkages may include hashes computed based on prior entries in the ledger, which may be utilized to determine whether a ledger entry is a fraudulent entry by reviewing the correctness of the hash based on performing the hash on information stored on prior entries.

The ledger may be maintained through, for example, a “distributed network system”, the distributed system providing decentralized control and storage of the ledger at the one or more entities (which may be considered “nodes” of the system). The number of “nodes” may be fixed or vary with time, and increasing or decreasing the number of “nodes” may impact the performance and/or security of the system. The ledger copies stored and maintained at each “node” provide cross-validation with one another in the event of conflicts between ledgers, and various cryptographic and/or hashing algorithms may be utilized during the generation, updating, deletion, linking, etc., of ledger entries such that ledger entries have increased resiliency to unauthorized tampering or modification.

For example, a blockchain ledger may be distributed across entities 102, 104, 106, 108, 110, and 112 and used to track information relating to various assets, obligations, contracts, documents, etc. The blockchain ledger may have entries linked to one another using cryptographic credit records, and entries in the blockchain may be ordered, time stamped, and/or associated with metadata such that the blockchain is designed for protection against “double” transfers and unauthorized modification of ledger entries.

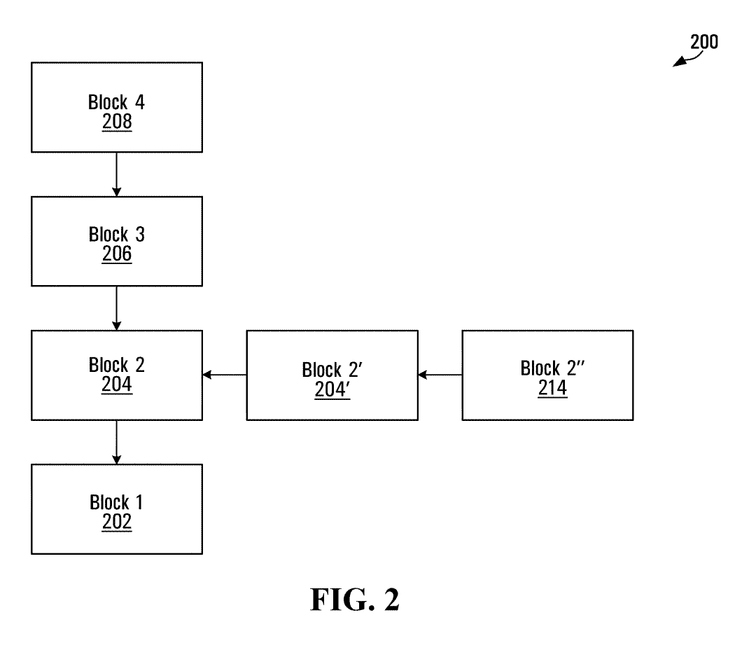

FIG. 2 depicts a sample blockchain 200, according to some embodiments. Block 1 202, block 2 204, block 3 206, and block 4 208 illustrate example blocks that provide a digital identity record used for credit score calculations.

In some embodiments, each block includes one or more identifiers of a set of identifiers for a respective digital identity record along with transaction data or other data used to assess creditworthiness of a borrower. For example, an identifier may be an identification number (IN) such as a passport number or a social insurance number. The block also includes a timestamp indicating when the block was created. If there is more than one block in the blockchain 200, each block beyond a first block further includes a hash of a previous block in the blockchain. A block can include a universal identifier assigned to the individual and linked to the set of identifiers.

An identifier is a value or data element that uniquely identifies a borrower. A unique borrower may be associated with a set of identifiers. Different data sources and data elements may be linked to different identifiers for a unique borrower and using a set of identifiers provides increased flexibility for linking data elements to the unique individual. For example, a passport number may provide a mechanism to link international data to an individual and a social insurance number may provide a mechanism to link national data to the same individual. The social insurance number and passport number are both part of the set of identifiers for the individual. A driver's license number is another example identifier that can be part of the set of identifiers for the individual. Other examples include email address, credit card number, health care number, account number, student number, and so on.

A digital identify record is made up of a set of blocks (e.g. block 1 202, block 2 204, block 3 206, and block 4 208). Each block for a particular digital identify record includes an identifier of the set of identifier for the same unique borrower (e.g. identifies the same individual). Different digital identify records are provided by different sets of blocks that include identifiers from different sets of identifiers for different borrowers.

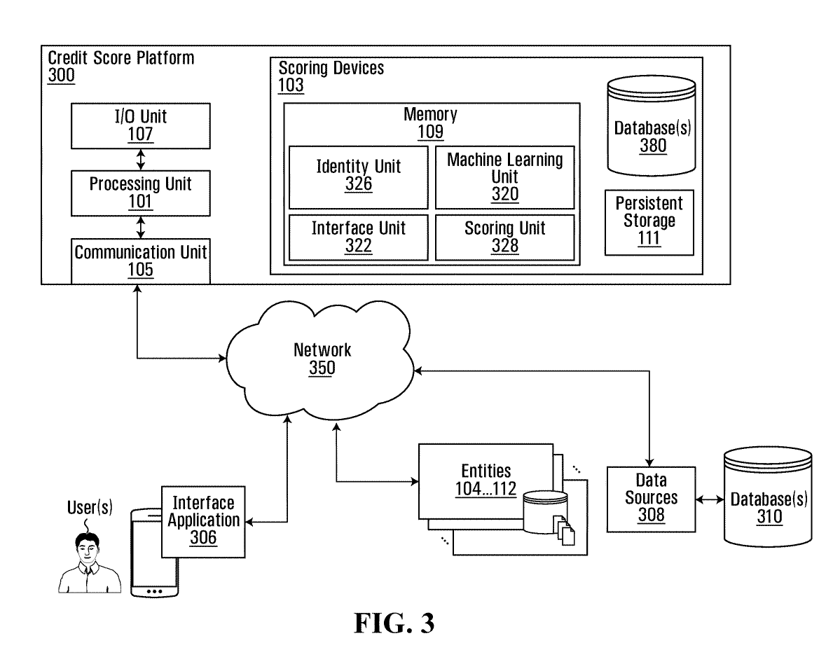

FIG. 3 is a schematic diagram of an electronic credit score platform according to some embodiments. Entities 102, 104, 106, 108, 110, and 112 have a credit score platform 300 to create and manage credit scores and digital identities using an identity processor 302 and blockchain storage 304.

The credit score platform 300 generates credit and digital identity records. The credit score platform 300 can include persistent storage 111 that maintains a distributed ledger of a plurality of nodes or interacts with a set of entities 102, 104, 106, 108, 110, and 112 that maintain the distributed ledger of nodes. The distributed ledger has a plurality of blocks. Each block has identification data linked to a set of identifiers for an individual, transaction data, a timestamp indicating when the block was created, and a hash reference for the distributed ledger. Credit history records are maintained using the blocks of a blockchain for the distributed ledger in some embodiments. Credit history records store information about the life of the individual and the creditworthiness. An individual may be able to register to create a credit history record. Third parties may also be able to register to add to the credit history record of an individual. The credit history record has an initial block (e.g. block 1 202) that includes registration, attributes, and permission attributes for the credit history record. The credit history registration may be completed by the individual or an interested third party, for example.

An identity unit 326 can be configured to provide a credit history application to register an individual corresponding to a first set of identifiers. The identity unit 326 can record a set of blocks of the plurality blocks on the distributed ledger, each block of the set of blocks having an identifier of the first set of identifiers. The set of blocks including an initial block for the individual registration. The initial block has attributes for the individual, and permission attributes.

The identity unit 326 can receive notification of a credit event for the individual. The notification having an identifier of the first set of identifiers. The identity unit 326 can record an additional block on the distributed ledger. The additional block can have the identifier of the first set of identifiers and credit event attributes. The identity unit 326 can interact with the machine learning unit 320 in order to create the block as there may be rules specific to different types of credit events.

The identity unit 326 can generate the credit history record using the first set of identifiers. The credit history record includes a credit score, the set of blocks and the additional block. Each block of the credit history records has an identifier of the first set of identifiers. The identity unit 326 can interact with the interface unit 322 to transmit the credit history record to an interface, enterprise system or external system. Each credit record in the credit history record is indexed by an identifier of the set of identifiers for the individual. Each block of the credit history record is linked by an identifier in a common set of identifiers. For example, a set of identifiers can be a social insurance number, credit card number, name, email address, and passport number.

The identity unit 326 can be configured to provide a digital identity application. The identity unit 326 can assign a universal identifier to the individual. The universal identifier can be used to index the set of identifiers. The identity unit 326 can record an additional set of blocks of the plurality blocks on the distributed ledger. Each block of the additional set of blocks includes the universal identifier and a different identifier of the first set of identifiers. The identity unit 326 can generate a digital identity for the individual using the additional set of blocks and the universal identifier. The identity unit 326 can use the credit history application to generate the credit history record using the digital identity to construct the set of identifiers.

The identity unit 326 can be configured to provide credit history application to calculate a change in the credit score based on the credit event. The interface unit 322 can generate a credit alert indicating the credit event and the change in credit score for the individual. The set of identifiers for the individual can include an electronic address for transmission of the credit alert. The scoring unit 328 is configured to generate or compute the credit score using the credit history record.

The identity unit 326 can be configured to provide credit history application to determine one or more credit actions in response to the credit event using a smart contract related to the credit event and the individual. The smart contract including an electronic signature and transaction terms. An example credit action based on terms of a smart contract can be a penalty payment that can be triggered when the credit event indicates a late payment on a loan, for example.

The interface unit 322 can indicate that the notification for the credit event indicates a violation of the smart contract.

The machine learning unit 320 can be configured to provide a smart contract middleware application to detect violation of a term of a smart contract linked to the identifier as the credit event and trigger the notification of the credit event in response. The smart contract includes an electronic signature and transaction terms.

The machine learning unit 320 can be configured to provide a security unit to receive a registration request to register the individual from a registration system, and verify the registration system prior to registration of the individual.

The machine learning unit 320 can be configured to provide a security unit configured to verify the interface, the enterprise system or the external system using the permission attributes before providing access to the credit history record.

The machine learning unit 320 can be configured to provide a security unit configured to verify credit event for the individual prior to recording the additional block.

The machine learning unit 320 can be configured to provide a credit marketplace engine configured to generate a listing of loan offers for the individual based on the credit history record, each loan offer indicating a creditor and loan terms, receive a selected loan offer indicating a selected creditor and selected loan terms, generate a smart contract with the selected loan terms, and record a new block on the distributed ledger, the new block having the smart contract, the identifier and the selected creditor, the smart contract being linked to an identifier of the set of identifiers and the selected creditor, the smart contract having an electronic signature and transaction terms.

In some embodiments, interface unit 322 can generate a notification for the credit event that indicates a violation of the smart contract, such as a missed payment.

The machine learning unit 320 can be configured to provide the credit marketplace engine to receive a loan request for the individual and generate a listing of loan offers for the individual based on the credit history record, each loan offer indicating a creditor and loan terms. The interface unit 322 be configured to provide a creditor and debtor application to transmit the credit history record to a creditor at an interface application 306, receive a bid for a loan for the individual from the creditor, transmit a notification of the bid to the individual; and receive an acceptance of the bid from the individual. The bid can indicate transaction terms.

The machine learning unit 320 can be configured to provide the smart contract middleware application to generate a smart contract, and record a new block on the distributed ledger, the new block having the smart contract. The smart contract can include an electronic debtor signature, an electronic creditor signature, the transaction terms, and an identifier of the set of identifiers.

The interface unit 322 can provide the creditor and debtor application to calculate the transaction terms based on the credit history record.

The interface unit 322 can provide an integration middleware layer configured to: determine that the transaction terms are satisfied; trigger notification of the credit event based on the determination; and record another block on the distributed ledger for the loan, the other block comprising the identifier of the set of identifiers and creditor identification. The integration middleware layer can receive payment notification for the loan; trigger notification of the credit event based on the payment notification.

The interface unit 322 can provide a security unit configured to verify the creditor by receiving creditor credentials, and comparing the creditor credentials to the permission attributes prior to providing access to the credit history record.

The integration middleware layer configured to receive a debtor registration request for the individual, the debtor registration request indicating individual; verify the debtor registration request; trigger generation of the universal identifier by the digital identity application, and generate an initial block for the credit history record, the initial block indicating the universal identifier and debtor attributes.

The interface unit 322 can provide the creditor and debtor application to receive a creditor registration request for the creditor, verify the creditor registration request, and generate an additional block for the credit history record. The additional block includes creditor attributes, the transaction terms, and an identifier of the set of identifiers.

The credit marketplace engine is configured to receive a loan search request with a set of parameters and identify the listing of loan offers based on the loan search request by comparing the set of parameters to loan data.

The interface unit 322 can provide an alert and notification unit configured to generate a credit alert for the individual indicating the credit event and transmit the credit alert to the individual using the first set of identifiers. The credit alert provides a way to keep people apprised of their actions and its impact on their credit score. The credit alert can indicate that certain things can impact the credit score and also to what extent. For example: if an individual applies for three credit cards (credit event), new telecommunications connection (credit event) and a personal loan (credit event) in a period of time then the credit score could go down by 30 to 40 points. The credit alert can indicate this data as new blocks record the credit events. The credit alert can also indicate to the individual that if they do certain things (e.g. credit events) then there is a net impact to their credit score. For example after applying for two financial cards (e.g. credit events) and one personal loan (e.g. credit event) then the credit score went from 740 to 720. Accordingly, the credit alert can indicate the credit event and the impact on the credit score (e.g. point impact, net impact). The credit alert can also indicate what credit events can increase credit scores. When a credit event is detected and there is a credit score change then the individual gets an indication. Third parties can also register to receive credit alerts for a particular individual. In some embodiments, the third party requires authorization by the individual before receiving credit alerts relating to the individual.

The identity unit 326 can configure the credit history application to interact with the scoring unit 328 to determine an impact of the credit event on the credit history record of the individual. The interface unit 322 can transmit a credit alert indicating the impact to the interface application 306. The scoring unit 328 computes a credit score based on the credit history record of the individual and generate a credit score notification indicating the credit score and the credit event.

As noted, the interface unit 322 and machine learning unit 320 can provide credit marketplace engine configured to generate a listing of loan offers for an individual based on a credit history record generating by a set of blocks. Each block of the set of blocks has an identifier of the set of identifiers. Each loan offer indicates a creditor and loan terms. The interface unit 322 can provide a creditor and debtor application configured to receive a selected loan offer indicating a selected creditor and selected loan terms; transmit a notification of the selected loan offer to the creditor; and receive an acceptance of the selected loan offer from the creditor. The machine learning unit 320 configures A smart contracts middleware layer to generate a smart contract with the selected loan terms. The smart contract being linked to an identifier of the set of identifiers and the selected creditor, the smart contract having an electronic signature and transaction terms.

The interface unit 322 configures an integration middleware layer to record a new block on the distributed ledger, the new block having the smart contract, the identifier and the selected creditor.

Interface unit 322 receives credit data from multiple data sources 308 to generate blocks stored in blockchain storage 304. Example data sources 308 include third financial institutions, retailers, social networking platforms, insurers, educational institutions, credit bureaus, credit services, telecommunications companies, and other third party services that collect information on individuals that may be directly or indirectly relevant to the creditworthiness of an individual. For example, a social network platform may provide social data relating to a peer group that may be relevant to the creditworthiness of an individual in addition to financial data relating to the individual.

Scoring processor 306 computes credit scores on demand and in (near) real time in response to credit requests received at interface processor 308. Identity processor 302 manages data for digital identities. Identity processor 302 computes a set of identifiers as a digital identity for a user. Credit data is stored as blocks in blockchain storage 304 and each block identifies at least one identifier linked to a digital identity. Scoring processor 306 interacts with identify processor 302 to identify blocks in blockchain storage 304 that relate to a particular digital identity to generate a credit score for a borrower linked to the digital identity. Scoring processor 306 defines credit score calculations based on credit data and weightings for different credit data metrics. For example, recent mortgage data may have a higher weighting than historical data from a car rental when generating a credit score. Machine learning processor 310 trains using different learning processes on data stored in blockchain storage 304 to refine and update credit score calculations for scoring processor 306. Machine learning processor 310 also refines and updates digital identities using different learning processes on data stored in blockchain storage 304. For example, digital identities can include images of faces of individuals and machine learning processor 310 can implement face recognition to identify individuals and expand digital identity data. Further, machine learning processor 310 can verify and validate data stored in blockchain storage 304. For example, digital identities can include signature data and machine learning processor 310 can implement handwriting recognition to identify individuals and verify credit data. Interface application 312 submits credit requests and credit data to credit score platform 300 and receives visualizations of credit data and credit scores for display on user device. Scoring processor 306 can interact with machine learning unit 320 to calculate credit scores using rules.

Credit scores and digital identities are maintained using blocks organized in blockchains stored in blockchain storage 304 of entities 102, 104, 106, 108, 110, and 112. Credit scores and digital identities represent data about the credit life of borrowers. Borrowers are registered on the credit score platform 300 by a digital identity to track block data received from different data sources. Third parties can submit credit information by creating blocks on a blockchain linked to digital identities. The blocks represent a dynamic storage system that tracks credit information. The digital identity record has an initial block (e.g. block 1 202) that includes user registration, user attributes, and permission attributes for the digital identity record. The user registration and credit information may be completed by lenders, credit bureaus, businesses involved in transactions with users, communications companies or leasing organizations, for example.

The permission attributes authorize entities 102, 104, 106, 108, 110, and 112 to create a new block using identity processor 302. The new block is linked to the set of blocks of the credit record using a set of identifiers. Each borrower or debtor has a set of identifiers that link blocks of credit data to the respective borrower or debtor. For example, identity processor 302 generates and assigns a global or universal identifier to a borrower. The global identifier links to different types of identifiers, such as name, date of birth, email, telephone number, social insurance number, passport number, and so on. The entities 102, 104, 106, 108, 110, and 112 can update an existing block in the set of blocks of the credit record and link the block to a digital identity. The permission attributes authorize entities 102, 104, 106, 108, 110, and 112 to delete or mark an existing block in the set of blocks of the credit record in the event of inaccurate information that may be flagged by a dispute resolution or review process. The interface unit 322 may use permission attributes for such verification or authorization. Authorized entities 102, 104, 106, 108, 110, and 112 retrieve the credit and transaction data from one or more blocks in the set of blocks of the credit record that are linked to identifiers. For example, a network provider may create a new block for insertion into the set of blocks of the credit record to indicate unpaid bills. As another example, an organization may create a new block for insertion into the set of blocks of the credit record to indicate loan details. As another example, an organization may create a new block for insertion into the set of blocks of the credit record to indicate a new credit card application. Authorized entities 102, 104, 106, 108, 110, and 112 can be verified prior to granting write permissions to update credit records.

A credit record for a particular borrower is formed by a set of blocks linked by the digital identity. A digital identity for a particular borrower is formed by a set of blocks that are linked by a set of identifiers for the particular borrower. The digital identity (e.g. set of blocks for the set of identifiers) is linked to a universal identifier. Each block may indicate one or more identifiers. For example, a block can include a name and social insurance data linked to credit data for a loan. The identifiers can be verified. The name and social insurance data can be verified. Each credit record block is indexed by a universal identifier uniquely identifying the particular borrower. Each block for the credit record has sufficient identifier(s) to identify the particular individual. For example, a date of birth alone may not identify an individual. Additional identifiers such as name, email, or address can be required. Different entities 102, 104, 106, 108, 110, and 112 can create or modify blocks for a credit record. Each block for a particular credit record will be linked by common identifiers of the same set of identifiers. The set of identifiers can be indexed by the universal identifier so that platform 300 has a unique system identifier for each individual.

The credit record has an initial block for that borrower or debtor indicating digital identity information. The initial block can also include references to additional blocks of digital identity data to expand the set of identifiers for the digital identity. The initial block may be created and entered on the blockchain by a financial institution, credit bureau and so on. The owner is granted ownership rights over the blocks for the credit record, and all subsequent blocks referencing a borrower using one or more identifiers for the digital identity.

A block of the credit record may store various data elements for the borrower and transaction information, for example, the nature of the transaction, parties to the transaction, document sections, contractual clauses, version information, and/or electronic representatives or derivatives of the same. The data can be verified. The blocks are stored in blockchain storage 304.

Credit data can include current and historical data from data sources 308 such as credit card data, bank account data, remittance data, transaction data, investment data, rental data (including car and housing rentals), employment data, education and qualification data, social data (e.g. social network data), retailer data, and so on. Another example is credit data from peer to peer lending platforms. A further example is data from pre-paid systems (e.g. stored value cards and accounts). For example, if a borrower regularly pre-pays $50 per month for a cable bill then this can be a good indicator of credit worthiness for $50 each month. Varied and comprehensive data sources 308 provide a thorough and holistic view of credit worthiness.

Traditional credit data used to generate credit scores is managed by credit bureaus and is received from a limited number of data sources. Credit score platform 300 receives credit data from multiple data sources 308 to generate the credit score and credit history record. Credit score platform 300 can verify or validate data sources 308 and credit data to confirm reliability. Credit score platform 300 may interact with interface application to verify or validate data sources 308 and credit data. Data sources 308 can receive data from different databases 310. Credit score platform 300 receives an increased amount of credit data from an increased number of data sources 308 to compute a credit score that more accurately reflects the creditworthiness of a borrower. Credit data can be received from data sources 308 in multiple countries. The credit data from a data source 308 can be linked to different identifiers of a set of identifiers for the individual, for example. The set of identifiers enables credit score platform 300 to aggregate the credit data from different data sources 308. A person or business may move to a new country and traditional credit scores do not factor in historical data from other countries even though the data provides a good indication of the creditworthiness of the borrower. Credit scores are often country specific and the current global workforce increases mobility between countries. People that relocate to a new country should not start the credit process from scratch and this may not accurately reflect the creditworthiness of the individual. Important credit data from other countries will be lost.

Additional data points help better understand credit capacity and provide further useful and valuable metrics to assess creditworthiness.

Traditional credit score processes are not transparent. A person's credit score may be negatively impacted by credit data without the borrower's knowledge. The data source may not be reliable and the person may not understand what credit data and data source impacted their credit score. People do not understand how their score is generated and do not have the tools to take control of their credit score. People do not have control to fix or improve their credit scores as there is no transparency regarding the data sources and events that triggered the negative impact. There is also no transparency around how the credit score is calculated. It can take a person a long time to generate new credit data that improves or fixes their credit score (relative to short time to generate credit data that can destroy their credit score). Embodiments described herein receive credit data as input from multiple data sources to generate credit scores. Credit score platform 300 generates visualizations for interface application 306 on user device to indicate collected credit data, data sources 308, credit alerts, and the process for generating their credit score to increase transparency in the credit scoring process. The interface application 306 can indicate what collected credit data and data sources are verified. The interface application 312 can interact with scoring unit 328 to provide a visualization of how the credit score is calculated including weighting of different credit data. Further, the interface application 306 enables a borrower to mark or flag collected credit data and data sources to dispute contentious or unverified data.

The persistent storage 111 and interface unit 322 enables credit data entries (e.g. blocks) from multiple different data sources 308 to generate credit records. The interface unit 322 interacts with interface application 306 to generate a notification or credit alert to a user device when new credit data is added to the storage 111 that impacts their credit score or is about to impact their credit score (e.g. close to threshold). For example, a notification or credit alert may indicate that an individual missed a bill payment and advise that another missed bill payment may negatively impact their credit score. Traditionally, credit checks can negatively impact a borrower's credit score. However, evaluation of credit data and credit score calculations is valuable for a user to take control of their credit and improve their credit score. The interface application 306 provides a helpful visualization of credit data, data sources and credit score calculations to empower a borrower with credit knowledge. A user will be notified when third party credit checks happen or when the credit score changes.

Machine learning unit 320 is configured to detect predictions for credit data that impacts credit scores to trigger alerts and notifications. For example, machine learning unit 320 processes credit data relating to transaction behavior to define rules for predicting impact on credit scores. The machine learning unit 320 interacts with interface unit 322 to trigger credit alerts and notifications to help a borrower change bad credit behavior or encourage good credit behaviour. The predicted impact on a credit score triggers credit alerts borrowers thus giving them an opportunity to change their behavior. Machine learning unit 320 implements preventive measures using predictive credit alerts to improve credit scores. The interface unit 322 interacts with interface application 306 to transmit the notification to a user device when predicted impacts from credit data are detected by machine learning unit 320.

Scoring unit 328 receives a credit request for a borrower from e.g. a potential lender. Scoring unit 328 interacts with identity unit 326 to compute the digital identity for the borrower which includes multiple identifiers stored as one or more blocks in storage 111 (or distributed storage across entities 104 . . . 112). Scoring unit 328 uses the identifiers to retrieve credit data relevant to the borrower. The identifiers can connect global data points (e.g. global banking network). Scoring unit 328 aggregates data points of the credit data in a cohesive manner to generate the score. Scoring unit 328 aggregates the data points of the credit data using weights so that some data points have a greater impact on the credit score than other data points. Machine learning rules 320 refines the score calculation or formulae based on training results to update credit score calculation. This enables re-use of credit data but with an improved or refined scoring formulae to increase the accuracy of the credit score as indicating creditworthiness. For example, the scoring formulae may consider credit data from an extended family to generate a “household” score or credit capability. Machine learning rules 320 can learn behaviours that implicate credit ability, such as spending patterns and payment patterns.

Identity unit 326 maintains a dynamic and evolving digital identity for each borrower or debtor to increase the amount of credit data that can be collected and used as part of the scoring process. A digital identity is defined by a set of identifiers and indexed by a universal identifier. A digital identity uniquely identifies a borrower or debtor. The set of identifiers can be stored as blocks in the storage 111. A digital identity can link to other digital identities. For example, an identifier of a digital identity for a borrower can link to other digital identities of related entities such as family members, for example, to provide a greater view of credit data. An identifier can link to global or universal identifiers to track and collect global credit data that may not be otherwise linked to a national identifier. For example, a social insurance number is a national identifier that can link to global identifiers such as a digital face image, biometric data, passport number, passcodes, name and so on. The identifiers are linked by blocks in the storage 111 as a dynamic digital identity record. Example identifiers include an international identifier such as name, data of birth, passport data and national identifiers such as social insurance number, bank account, and so on. The identifiers can be verified and provide a collection of identification sources to link a greater amount of credit data for a borrower.

The interface unit 322 receives a reporting request directly from lenders, credit bureaus, service providers, agents and so on. The interface application 306 can be used to generate reporting requests. This enables direct reporting to the storage 111 (which can also be distributed across entities 104 . . . 112 as described herein). The reporting request indicates credit data and one or more identifiers. The interface unit 322 uses the reporting request to generate blocks that indicate credit data and one or more identifiers. The blocks can be verified or validated and the validation information can also be stored as part of the blocks. The validation information can be used for weighting credit data for credit score calculation. For example, verified or validated credit data may be given a higher weighting than unverified credit data. The interface unit 322 can have rules that trigger or provide notifications to borrowers when new blocks of credit data with one or more identifiers linked to their digital identity.

The interface application 306 provides a visualization of credit data and credit scores for display on a user device. For example, there can be a visualization of the credit score to show the breakdown of the credit score and provide an understanding of how the credit score is generated. The interface application 306 provides a visualization of the credit data which includes financial and credit data along with social data (e.g. employment, education, family), utility data, property data, asset data, and so on. The interface application 306 provides a visualization of data points and weightings to understand impact of credit data points and factors on the credit score. The interface application 306 provides a visualization that highlights negative impact and positive impacts on the credit score. The interface application 306 provides an interface with gamification features to encourage improved credit scores. The interface application 306 can display credit alerts for the debtor.

Credit data is represented by blocks in the storage 111 which can be distributed across entities 102, 104, 106, 108, 110, and 112. The blocks may be connected to one another through various linkages, for example, each linkage may be formed based on a hash computed from part or all of a previous block or a portion thereof (e.g. an identifier). For example, as shown in FIG. 2, Block 1 202 may be the initial block, and Block 2 204 may be connected to Block 1 202 and include a hash computed from Block 1 202. There may be various versions of blocks, for example, Block 2′ 204′ and Block 2″ 204″, which may, for example, be updated and/or modified versions of credit or transaction information stored in Block 2 204. Other implementations, topologies and/or arrangements may be provided, and the above is merely an illustrative example.

The example blockchain may have more, less, and/or different blocks. Blocks can be inserted, deleted, updated, modified, transformed, etc., over the course of time. The example blockchain may include one or more credit records. Block linkages may also be between two or more blocks. For example, in some embodiments, blocks contain linkages to a single prior block, two prior blocks, and/or all prior blocks.

Authorized entities 102, 104, 106, 108, 110, and 112 can be granted permission attributes or access to write new blocks to the blockchain using the interface processor 308. Authorized entities 102, 104, 106, 108, 110, and 112 update credit records with different credit related transactions and events. For example, a new block can indicate that a bill payment was missed, that a borrower repaid a mortgage, or possibly other events, such that a spouse recently purchased a new asset. Access to write new blocks for a credit record can be restricted to those trusted authorized entities 102, 104, 106, 108, 110, and 112. An authorized entity 102, 104, 106, 108, 110, and 112 can be verified before writing new blocks for a credit record. When an entity 102, 104, 106, 108, 110, and 112 writes a block to an existing distributed ledger, the borrower linked to the credit data may be notified by way of a notification message, such as an email, text, or through the interface application 312 specific to the platform.

In some embodiments, if an authorized entity 102, 104, 106, 108, 110, and 112 wishes to write information about a borrower that has not yet been registered to the platform (e.g. no existing blocks for its credit record), the authorized entity 102, 104, 106, 108, 110, and 112 can still create the initial block for a credit record for the borrower using the interface processor 308. The credit score platform 300 can be configured to send a notification message to the borrower or government agency (that manages identification of its nationals) using contact data known to the authorized party that created the initial block or otherwise known to the credit score platform 300. In some embodiments, a verification or approval response is required from the borrower (via platform 300 or interface application 312) before the initial block can be created by another authorized entity 102, 104, 106, 108, 110, and 112. The notification message can invite the borrower to register with the platform. If no contact information is available to the authorized entity 102, 104, 106, 108, 110, and 112, the platform 300 may notify a lender, credit bureau or government agency, so that they may then notify the borrower.

A credit record can track recent and historical data for the borrower linked to a digital identity. A credit record is recorded using blocks and each block includes at least one identifier in the set of identifiers linked to the digital identity identifying the borrower. The digital identity connects blocks for the credit record. A credit record can be dynamically compiled by identifying and aggregating all blocks with identifiers linked to a digital identity uniquely identifying the particular borrower. The borrower and particular authorized entities 102, 104, 106, 108, 110, and 112 are able to view the complete credit history tracked by the credit record by way of an interface application 306. The information for the borrower (and transactions relating to the borrower) can be stored on different blocks and the interface application 306 is able to retrieve information from all of the blocks making up the credit record, and present it in a user readable manner. The interface application 306 may provide a perspective that does not require knowledge of the technical backend of blocks or blockchains. In some embodiments, unauthorized users will not be able to retrieve information on other individuals, but might be able to query the blockchain for an individual using identifiers to see if they are registered with the ledger or not. The borrower may be notified when someone has queried for their credit record.

Credit information is valuable when lending money or otherwise transacting with a borrower. A prospective lender may send a request to the borrower, or be granted permission from the borrower without sending the request, to access and view the blocks defining the credit record for the borrower. When a request is made using the interface application 306 to the platform 300, the request may be sent to the borrower and the request can be viewable by the borrower using another interface application 306. The borrower may approve or deny the request using the interface application 306 (e.g. clicking “OK” or whatever other indication is given to grant the requested access). Information about the party making the request may also be provided, including optional information on how the borrower may contact the requester. For example, the borrower wants to verify more information about the requester prior to granting access. The lender may then be able to read all of the information available on the credit record, trusting that it has not been manipulated by the borrower, as blocks to the blockchain might not be deleted or modified in some embodiments. The access granted may be time-limited, or may be for a one-time-only access. If the lender lends money to the borrower then the transaction may be updated by the lender as a new block for the credit record to reflect the new credit data. A block of the credit record may include a smart contract for the transaction with certain conditions that can be evaluated by scoring processor 306 when generating a credit score, for example.

Information in the blockchain for the credit record may need to be updated, such as for example due to errors entering credit information, or conflicts in information between authorized parties. In some embodiments, the platform provides a correction or dispute resolution mechanism for correcting information in the blockchain for the credit record. If an authorized entity 102, 104, 106, 108, 110, and 112 or individual wishes to correct information in a block that the authorized entity 102, 104, 106, 108, 110, and 112 or other party created, it may create a modification block, which references the prior block and indicates what data should be updated and how. The modification block can also include a reason for the update or correction.

When retrieving the credit record by way of the interface application 306, the correction may show up in the form of an indicator showing that a particular piece of information was updated. The update history of that information can then be viewed, if it is not shown already in the initial view. In the case of a conflict between information (e.g. lender and borrower both updating information about the same transaction but the information does not match), notifications may be sent to both parties. The notifications can highlight discrepancies, and request that authorized entities 102, 104, 106, 108, 110, and 112 agree on a correction or other resolution to the conflicting information. The interface application 306 may automatically generate forms to provide information to the authorized entities 102, 104, 106, 108, 110, and 112 and receive information from the authorized entities 102, 104, 106, 108, 110, and 112. Once the conflict is resolved, a new block may be written to the blockchain for the credit record with information for the resolution. The resolution may be a correction of previously entered information on another block as well. The interface application 312 can generate a form with standardized data entry fields to allow for these automated conflict checks when entering new blocks to the credit record.

In some embodiments, the platform 300 can generate the recommended interest rate or other terms for a lending transaction using information stored in credit records and third party databases. The platform 300 can also connect with a database of historical financial data and related information to use as a baseline for a recommendation on lending terms.

To avoid borrowers and entities 102, 104, 106, 108, 110, and 112 entering fraudulent or inaccurate credit data, in some embodiments, only a verified entity 102, 104, 106, 108, 110, and 112 may be permitted to enter validated credit information as part of blocks of a credit record. A block for a credit record can have a data attribute identifying the creator of the block (e.g. as an authorized entity 102, 104, 106, 108, 110, and 112) to verify the accuracy of the information. In some examples, the write ability for entities 102, 104, 106, 108, 110, and 112 is limited to certain types of credit data.

The interface application 306 can be implemented using a mobile application or desktop application, for example. Information from third party databases can be used to update or create blocks for credit records using interface applications 312. For example, security agreement information relating to borrowers can be registered with the platform and viewed using the interface.

Embodiments described herein relate to credits records for tracking credit related information linked to borrowers to provide a better view of credit worthiness. Embodiments described herein can be applied to different types credit. Embodiments described herein apply to different types of borrowers and transactions.

Embodiments described herein can be extended to cover a variety of identifiers including driver's license information, corporate data, registrations, or other government records.

Embodiments described herein enable credit history to be captured from multiple disparate authorized entities 102, 104, 106, 108, 110, and 112. Embodiments described herein provide a dispute resolution tool in the event of inaccurate or disputed credit data. Smart contracts can be uploaded as blocks to resolve disputes. Embodiments use a distributed system with the embedded trust of blockchain technologies. The blocks for the credit record cannot be altered so trust is built into the structure for the records.

The credit record can provide a more accurate view of credit and rates depending on risks related to the credit history. Insurance claim records can be recorded is association with the credit record, for example. The credit record can in real-time (or near real-time) and be used to resolve discrepancies. The-smart contract can flag inconsistencies and resolve the inconsistencies using protocol rules. The credit record may include blocks that import credit history from third party data stores and link to the individual by its digital signature. A private key can unlock additional data (e.g. contents of smart contract). The interface application 312 can access a history report and check credit score status.

The credit record can be updated in real-time so that any relevant information is pulled automatically by credit score platform 300 from a third party database and is up to date.

The interface application 306 shares the credit data, credit alerts, credit events, notifications and reports with third parties (e.g. potential lenders). A borrower may not control all information that can be entered as part of the credit record. In some embodiments, the borrower can approve some entries but may not be able to approve all blocks recorded as part of the credit record. For example, bankruptcy agencies and courts can add events to the credit records.

A processing device 101 can execute instructions in memory 109 to configure identity unit 326, interface unit 322, machine learning unit 320, and scoring unit 328. A processing device 101 can be, for example, any type of general-purpose microprocessor or microcontroller, a digital signal processing (DSP) processor, an integrated circuit, a field programmable gate array (FPGA), a reconfigurable processor, or any combination thereof.

Memory 109 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Storage devices 103 include memory 109, databases 380, and persistent storage 111.

Each I/O unit 107 enables the platform 300 to interconnect with one or more input devices, such as a keyboard, mouse, camera, touch screen and a microphone, or with one or more output devices such as a display screen and a speaker.

Each communication interface 105 enables the platform 300 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 300 is operable to register and authenticate users (using a login, unique identifier, and password for example) prior to providing access to applications, a local network, network resources, other networks and network security devices. The platform 300 may serve one user or multiple users.

The blockchain ledger, through its distribution among multiple entities 102, 104, 106, 108, 110, and 112 and resulting decentralized control logic, may be less vulnerable to tampering than some other non-blockchain implementations (e.g., transaction records stored only at a single organization's computing systems). Further, the additional metadata stored in the blockchain entries may also be utilized to increase the efficiency of various operations being conducted related to the entries, such as validation, updating, analysis, etc. Various business rules may be applied, and activities may include, for example, business rule definition, business rule execution, business rule management, business rule monitoring, etc.

In this example, logic that may be utilized to increase the blockchain's resilience to tampering may include “majority consensus rules”, where a validation may be based on the integrity of a “longest” blockchain; cross-validation by multiple nodes to authorize an activity to modify the blockchain; using suitable encryption and cryptographic techniques (e.g., public/private key pairs, hashing, “proof of work” generation); among others. For example, if a new “block” being proposed by one of the entities does not conform to one or more rules and/or requirements, the block may be rejected and/or subject to further scrutiny before it can be accepted and properly inserted into the blockchain.

In some embodiments, the distributed ledger is utilized to track credit related contracts and/or business agreements through a document or contract lifecycle. The distributed ledger (e.g., implemented using blockchains) writes various versioning information, content information, clause-specific information, etc. The platform 300 implements a distributed ledger to capture credit related data from one or more (e.g., all) clauses of a variety of types of business agreements/contracts using a high-level domain specific language (“DSL”). The platform converts contracts into scripts for execution. Among other information, the version of the contract that is described in the DSL may be written to a blockchain distributed ledger.

By using a blockchain distributed ledger, each party may be able to rely on the DSL-expressed contract to be tamper resistant (and in some embodiments, tamper-proof). A party may be permitted to access the contract stored on the ledger, and any changes made to the contract may be reflected with a new entry to the ledger. Previous versions of the contract may be maintained on the ledger, and may either link to or be linked from later versions of the contact. The links may take the form of a hashed key or reference as in other blockchain implementations. Auditing contracts may be possible using this structure as all events persist in the blockchain distributed ledger. Changes may include changes to fees or other terms, or terminating a contract. Agreements/contracts that are translated to the DSL and stored in this manner are not to be restricted to any particular type.

By expressing the contract in the DSL, it may be possible to automate various actions based on the DSL-expressed contract and/or the records stored on the blockchain distributed ledger. For example, once a condition from the contract is satisfied (e.g., a date/time is reached, or the price of an object or asset has passed a particular threshold), one or more computer servers hosting or interfacing with the ledger may trigger an action. Actions may include initiating, modifying or cancelling a financial transaction, triggering another condition in the same or another DSL-expressed contract, or generally enforcing any one of a variety of legal obligations as defined by the contract. When a DSL-expressed contract is modified, such changes may also trigger notifications to the parties.

The blockchain may be operated by one financial institution, or a group of financial institutions, or other authorized entities 102, 104, 106, 108, 110, and 112 such as credit bureaus, lending institutions, government agencies, and so on. Each participating entity may operate as a node in the distributed network and may maintain a full copy of the ledger to be synchronized with the other entities when any change is proposed or made. By restricting the ledger to only particular entities 102, 104, 106, 108, 110, and 112 instead of to anyone with a computer (e.g., in distributed ledgers used for Bitcoins or other cryptocurrencies), clients may be more likely to trust that the entities will maintain the integrity and security of all data stored on the ledger behind a firewall.

A potential advantage to limiting the participating entities to authorized entities 102, 104, 106, 108, 110, and 112 (or another small group of entities such as mortgage companies, regulators, satellite offices) is that the number of nodes in the distributed network may be reduced (e.g., restricted, limited) in comparison to publicly distributed (or accessible) ledgers, and the financial institutions themselves may also be inherently more trustworthy than any number of unknown third parties. Accordingly, any consensus process, where different nodes on the distributed network must agree on any changes made to the ledger, may be simplified and overall performance of the ledger (e.g., transaction speed) may be increased over public distributed ledgers. For example, a more rigorous consensus process may be applied in view of common standards enforced across the entities, or the ledger may be constructed and configured such that greater efficiencies may be obtained during access, traversal, modification, etc. In some embodiments, the ledger, in an example blockchain distributed implementation, may be adapted such that the linkages between various “blocks” are designed to facilitate access and/or traversal of the blockchain in view of operations that may be implemented using, at least in part, information stored in the blockchain.

Blockchain Implementation

A blockchain (or “block chain”) is a term describing a linked group (database, ledger, or “chain”) of data structures called “blocks”. Each “block” may, for example, represent credit or related data for a credit record. A transaction occurs between one or more users, and may include a reference to another block (or more than one block) in the chain that represents related credit data. In some embodiments the block also references an immediately preceding transaction involving the same transferred data; and/or the initial creation of the data.

In some existing implementations, the data being transferred in the blocks may be referred to as cryptocurrency, but in some embodiments described herein, the blockchain technology may be extended and/or adapted in relation to other types of data. A known implementation of a blockchain-based cryptocurrency is Bitcoin. In some embodiments, the data stored in the blockchain may also be associated with a physical currency transfer, the blockchain serving as a record of the transaction details that can be accessed to, for example, validate, audit, and/or review transactions as part of credit records.

In some embodiments, to maintain integrity of data transferred using a blockchain, ownership of the data may be designed such that ownership is restricted to transfers between users using the blockchain, and not by any other means. The data being transferred may be data that originated from a secure storage 304 on a first user's computing device, and that data may be transferred to a second user's computing device.

Credit data may be verified, for example, by configuring the system such that the first user signs the transferred data with a private encryption key. A creation of a block in the blockchain for that transferred data may allow the transfer to occur. Each block may be created in accordance with specific secure protocols typically by one or more computers on a public distributed network. For example, blocks may be created by a process called “mining” which involves numerous computers on the network performing complex mathematical computations. The mining process of block creation is designed to eliminate the risk of a user creating or modifying blocks for the user's own transactions. While mining is one way of creating blocks, there may be other ways and/or other technologies used in the creation of blocks. In some embodiments, blocks are created without a mining process and hashes (e.g., computationally “unique” hashes) may be assigned to various blocks instead.

Blocks may be created (e.g., as an originating block or a block having linkages to previous blocks), and upon creation, the block may require insertion into the blockchain by the distributed network if it is not the first block. If it is the first block, a new blockchain may be established. The blocks link to the credit record using the set of identifiers, for example.

In some implementations, the amount of time for insertion and/or validation may be not insignificant. It may take several minutes or longer for a block to be created and validated for insertion into the blockchain by the distributed network. The transaction may not complete until the block is successfully created and inserted in the chain. In accordance with some embodiments, the blockchain and/or blocks themselves may be configured to reduce the amount of time needed for validation and/or insertion, as such time may lead to vulnerabilities in the integrity of the blockchain.

Blocks in the blockchain may be stored and shared across computers in the distributed network, such that each computer, or node, in the network maintains an updated storage of all existing blocks (e.g., on a continual basis, on a periodic basis). In some embodiments, the entire blockchain for each block may be accessible to each node in the distributed network, and each node may be able to trace back the history and original creation of the transferred data by looking at one block and retrieving previous blocks in the chain starting from the reference contained in the last block. Accordingly, it may be difficult to tamper with a block embedded in the blockchain as modifications may be readily identified through computing the hashes based on following entries (e.g., the computed hashes do not match).

Each block in a blockchain may include, for example: credit information including identification of the borrower and any related data. The data can also include a timestamp indicating the time of the transaction; a hash of the immediately preceding block representing the same cryptocurrency; and a hash of the current block. Other security data may also be included, depending on the particular blockchain implementation. The credit information may also be encrypted in some cases, and either the transaction information or the block itself may be digitally signed by the transferring user's private key.

Blockchain implementation may provide several advantages, including, but not limited to:

(i) blockchains that are difficult to tamper with (e.g., relative to unencrypted, non-blockchain or centralized implementations); for example, a specific block in a blockchain may be computationally impractical to modify once a series of blocks has been “chained” off of the specific block, as each subsequent block in the chain would also have to be located and modified;

(ii) transactions involving a blockchain that can be verified by various parties (e.g., anyone) back to the original creation of the data being transferred, which may be helpful for auditing purposes and may entirely prevent money laundering, counterfeiting of cryptocurrency, or other fraudulent transaction-based activities;

(iii) the distributed nature of most blockchain implementations may provide that one dominant party is unlikely to have a monopoly over transactions using the blockchain;

(iv) control of the blockchain through design parameters of the blockchain, for example, wherein the creation of data or cryptocurrency to be transferred with a blockchain is verifiable as the total amount of cryptocurrency available for exchange using the blockchain may be strictly controlled (e.g., blocks, blockchains, data and/or cryptocurrency could also be removed from circulation if desired);

(v) widespread adoption across developers as many developers around the world are working on applications for blockchain in a variety of fields, not limited to just finance, and a blockchain-based solution may eventually form the basis for most private, secure internet-based communications over public networks;

(vi) an ability to implement transactions with more time flexibility, as blockchain-based transfers may occur at any time, including weekends and holidays, and are not restricted to any particular entity's business hours;

(vii) the ability to provide difficult to reverse and/or irreversible transactions, providing certainty for users receiving the data (e.g., a separate transaction may be subsequently agreed upon between the parties to return the transferred data); and

(viii) an ability to remain anonymized, e.g., through the use of anonymous identifiers to mask the true identities of the users engaged in the blockchain-based transaction, even if information is shared with a public distributed network.

These are example features of blockchains. Blockchains may be well suited for scalable environments (e.g., the number of nodes can be scaled up and down), and/or environments where a high degree of decentralization and/or security are important. There may be simplified and/or potentially more trustworthy maintenance (e.g., through using a specific declarative architecture model), and improved operational efficiency as previously manual and/or cumbersome tasks may be aided and/or automated using the blockchain.

The blockchain may be implemented such that complex business rules may be expressed (e.g., process calculus implementations using calculus (or pi-calculus)), which may aid with modelling, expressing complex relationships and/or dependencies, manipulations, analyses, etc.

The particular design and implementation of a blockchain ledger may also require some trade-offs to be made in respect of security, efficiency, and robustness. Such design considerations may include, for example, what information to store on the ledgers; the level and/or complexity of encryption; the types of linkages between blocks; the number of nodes; the validation and/or processing rules; among others.

For example, some design considerations may include:

(i) susceptibility to security flaws (e.g., depending on the implementation, there may be a high degree of reliance on potentially unknown third parties to maintain the integrity of the blockchain's distributed network) that may also result in malicious attacks on the blockchain (e.g., against a public distributed network or on individual stores of cryptocurrency);

(ii) the time required to perform various transactions using a blockchain, this time may be significant (e.g., depending on the speed required, it may be unsuitable for some applications where fast or instant transactions may be desirable, but such drawbacks may potentially be mitigated through design);

(iii) potential collisions due to the nature by which subsequent blocks in a blockchain are created, as sometimes two or more blocks could be created that refer to the same immediately preceding block (e.g., appropriate mechanisms may be provided to handle such occurrences as it is preferable to have un-forked blockchains for transaction verification purposes); and

(iv) where blocks are created in multiple forks off of one block, only one of the forks will typically be preserved, while the other forks may be moved to another block—this may result in the correct history for such blocks being lost, or being more difficult to locate.

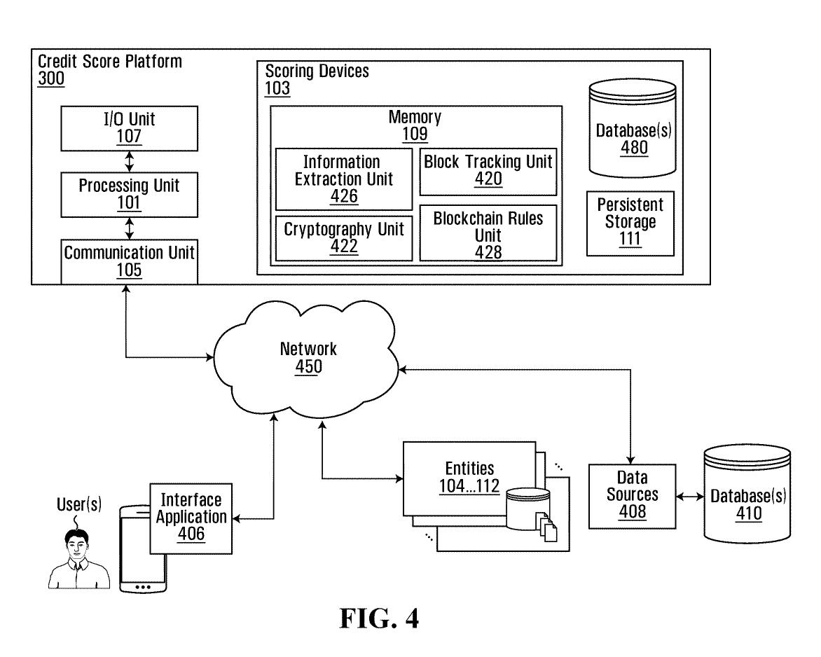

FIG. 4 is another schematic diagram of a credit score platform, according to some embodiments.

The credit score platform 300 manages credit records using blocks organized in blockchains. Any borrower or lender may be able to register their credit data on the blockchain credit score platform as an authorized entity.

The system may be comprised of one or more units being provided through various computing embodiments, such as using a combination of hardware, software, and/or embedded firmware. For example, the system and its units may be implemented using servers, processors, computer-readable memory, storage devices, etc. In some embodiments, the system may be provided by distributed resources (e.g., through a “cloud computing” implementation). The credit score platform 300 may be comprised of units, including an information extraction unit 426, a cryptography unit 422, a block tracking unit 420, and a blockchain rules unit 428. The credit score platform 300 may be configured to interact with an interface application 306, which for example, may be a user system and/or any type of automated system (e.g., interfacing through an API) that may be performing various activities in relation to the blockchain. For example, interface application 306 may be a financial institution computing device that indicates that a contract should be added to the blockchain ledger to record data relating to credit or a borrower as part of the credit record. The interface application 306 may provide this information through network to the information extraction unit 402.

The information extraction unit 426 may be configured for extracting various elements of information from information sources, such as contracts, transaction records, documents, financial statements, etc. These information sources may provide information in the form of electronic documentation, etc. In some embodiments, the information extraction unit 402 is configured to anonymize and/or redact information, and/or extract only a subset of information relevant to a particular purpose. This information may be stored at storage 103, 111 as a block of the credit record.

The cryptography unit 422 may be configured for encrypting and/or otherwise transforming information provided by information extraction unit 426, for example, applying various encryption algorithms and/or techniques (e.g., public key/private key encryption) to extracted elements of information. In some embodiments, the cryptography unit 422 may be configured to generate information which may be utilized in the formation and/or generation of one or more blocks for insertion and/or addition into the blockchain.

The block tracking unit 420 may be configured for maintaining relationships and/or associations identifying how blocks may be related to one another, and/or the identity of various blocks (e.g., identifying what information is associated with each block). The credit record includes blocks linked by the set of identifiers of the digital identity for a borrower. The block tracking unit 406 may be configured for identifying a set of blocks using the set of identifiers to generate reports for the credit record. The reports can be transmitted to interface application 306.

The blockchain rules unit 428 may be configured for maintaining and updating one or more blockchains, the blockchain rules unit 428 may be configured, for example, to apply, execute, update, etc., various rules and/or logic associated with the blockchain. For example, rules may be associated with consensus requirements and permission attributes for updating blocks, adding blocks and/or deleting blocks, validating new blocks, rejecting new blocks, etc. The rules can also trigger notifications to borrowers when new blocks are added that impact their credit score or credit record. The rules may be stored in the storage 103, or in the storage 111.

The storage 111 may be configured to store information associated with the blockchain, such as the blockchain ledger, blockchain entries, information stored on various blocks, linkages between blocks, rules associated with the blockchain, etc. Storage 103 and/or persistent storage 111 may be provided using various types of storage technologies, such as solid state drives, hard disk drives, flash memory, and may be stored in various formats, such as relational databases, non-relational databases, flat files, spreadsheets, extended markup files, etc.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

The platform 300 connects to other components in various ways including directly coupled and indirectly coupled via the network 350. Network 350 is capable of carrying data. Network 350 can involve wired connections, wireless connections, or a combination thereof. Network 350 may involve different network communication technologies, standards and protocols, such as for example Global System for Mobile Communications (GSM), Code division multiple access (CDMA), wireless local loop, WiMAX, Wi-Fi, Bluetooth, Long Term Evolution (LTE) and so on. Network 350 may involve different physical media such as coaxial cable, fiber optics, transceiver stations and so on. Example network types include the Internet, Ethernet, plain old telephone service (POTS) line, public switched telephone network (PSTN), integrated services digital network (ISDN), digital subscriber line (DSL), and others, including any combination of these. Network 150 can be a local area network or wide area network.

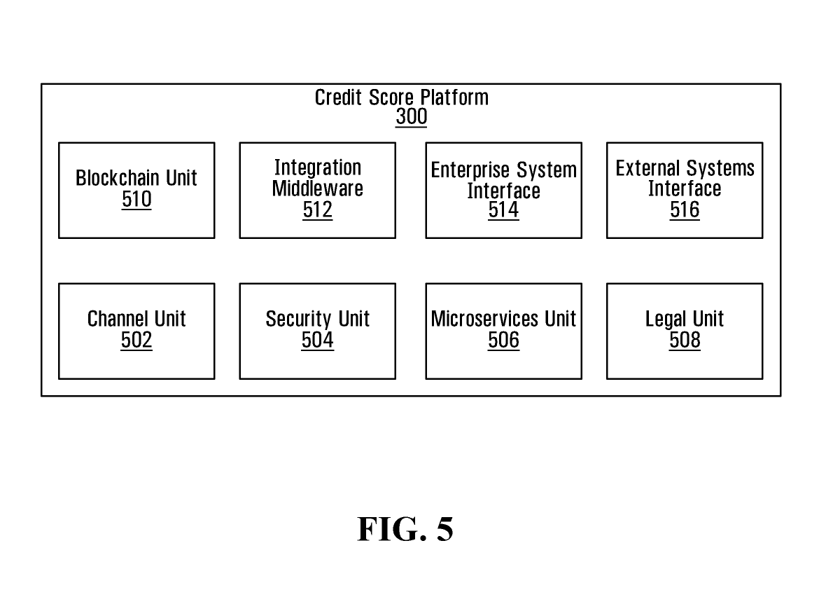

FIG. 5 is a schematic diagram of another electronic credit score platform 300 according to some embodiments. The credit score platform 300 can connect to or be implemented by entity nodes, for example. The credit score platform 300 includes a channel unit 502, security unit 504, micro-services unit 506, legal unit 508, block chain unit 510, integration middleware 512, enterprise system interface 514, and external system interface 516, for example.

The credit score platform 300 can implement distributed ledger and block chain infrastructure to create a safe and secure digital contracts system for creditors and debtors interested in forming a legally binding agreement for loan arrangements. The credit score platform 300 can build a system for borrowing and lending. The channel unit 502 can connect to one or more interfaces for different devices operated by stakeholders. The channel unit 502 can also integrate with different Internet of Things devices. The channel unit 502 can include different types of interfaces such as a mobile interface and enterprise interface. The security unit 504 can implement authentication, identity management, permissions and audit logging for example. The micro-services unit 506 can provide different services for creditors, debtors, and financial institutions. Example services include a loan marketplace and a credit record history. The legal unit 508 and block chain unit 510 implement smart contracts and write blocks to the distributed ledger. The integration middleware 512 can implement ledger integration gateways, payment services, and data analytics. The enterprise system interface 514 can integrate client profiles, payments, security, and other components with different enterprise systems. The external system interface 516 can connect to different 300 for different stakeholders in order to read and write to the distributed ledger.

The credit score platform 300 generates a distributed ledger with a plurality of nodes, for example. The distributed ledger has blocks. A block for a credit record includes an identifier, credit or transaction data, a timestamp indicating when the block was created, a hash reference for the ledger, and so on.

A credit score platform 300 has a micro-services unit 506 that can provide distributed applications to generate a credit history record of a set of blocks from the ledger. Each block of the set of blocks has identifier of the set of identifiers. The credit record can have an initial block of a debtor registration, attributes, and permission attributes for the credit history record.

The micro-services unit 506 can provide distributed applications that can be configured to receive a bid for a loan to a debtor, transmit a notification of the bid to the debtor, receive an acceptance of the bid from the debtor, and so on. The legal unit 508 can be configured to generate a smart contract for the loan or transaction, the smart contract including a debtor electronic signature, a creditor electronic signature, and transaction terms. The legal unit 508 can be configured to determine that the transaction terms are satisfied or violated, trigger a corresponding action, and record another block on the distributed ledger for the transaction, the other block comprising an identifier of the set of identifiers, creditor identification, and the smart contract.

The security unit 504 can be configured to verify the debtor by receiving debtor credentials prior to transmitting the notification, and verify the creditor by receiving creditor credentials and providing access to the credit history record. The security unit 504 can be configured to verify the debtor by receiving debtor credentials and compare the debtor credentials to the stored attributes. The security unit 504 can be configured to verify the creditor by receiving creditor credentials, compare the creditor credentials to the permission attributes, and provide access to the credit history record.

The integration middleware 512 can be configured to receive a registration request, verify the registration request, and generate an initial block for the credit history record with a universal identifier. The initial block can include registration data, the universal identifier, attributes, other identifiers, permission attributes for the credit history record, and so on.

The micro-services unit 506 can provide distributed applications that can be configured to receive a credit event identifying an identifier of the set of identifiers, and generate an additional block for the credit history record. The additional block can include debtor attributes, transaction details, data regarding the credit event, and so on. The credit event can positively or negatively impact the credit score. The micro-services unit 506 can generate a credit alert indicating the credit event and the impact on the credit score. The micro-services unit 506 can be configured to receive a credit event identifying an identifier of the set of identifiers linked to the individual, and generate an additional block for the credit history record. The additional block has attributes about the credit event, the source of the credit event, the identifier, and so on. The micro-services unit 506 can be configured to receive and process different types of credit events. Example credit events include default on a transaction term, bankruptcy, or other situation that can impact the credit worthiness of an individual or organization which may trigger insurance or penalty payments. A credit event can create a positive or negative change in a borer's credit standing or credit rating. A credit event can impact the borer's ability to repay its debt. Credit events include violating a loan agreement. Credit events include early repayment on the loan agreement.

The credit score platform 300 can be configured to receive a credit risk request for the debtor, generate a credit score for the debtor, and generate an additional block for the credit history record, the additional block comprising debtor attributes, the current credit score, and an identifier of the set of identifiers linked to the individual. The credit score platform 300 can be configured to receive a debtor search request with a set of parameters and identify the credit history record based on the debtor search request by comparing the set of parameters to the credit history data and identifier stored by the platform 300.

The credit score platform 300 has a block chain unit 510 to generate blocks for the distributed ledger. The distributed ledger can support the peer to peer loan marketplace, in some embodiments. The legal unit 508 can interact with the distributed ledger to validate contract negotiation protocol and transaction security. The credit score platform 300 provides a private or public block chain infrastructure with security, identity, and management services. The peer to peer loan marketplace can include a loan inventory management API, debtor or creditor onboarding API, bids and listings management API, contract lifecycle API, and so on. The distributed ledger generates credit history records to provide debtor identification, warranty information, authentication management, contract management, electronic signatures, bid management, and so on. The legal unit 508 can enable payments for finalizing or implementing terms of contracts. The legal unit 508 can interact with the enterprise system interface 514 or external system interface 516 for payment processing and transfer. The legal unit 508 can provide a legal contract repository and management applications. The legal unit 508 can provide identity services integration and a client matching engine. The legal unit 508 can integrate with payment services and can provide a mobile application user interface flow for the debtor and creditor. There can be mobile application integration with creditor APIs. The distributed ledger enables registration of debtors using blocks for the credit history record.

The credit score platform 300 enables off chain payments and on chain payments. The credit score platform 300 enables payment lifecycle using the distributed ledger. The credit score platform 300 can implement a bid process and listing matching process. The credit score platform 300 can provide notifications for debtors and creditors of bids and transactions. The micro-services unit 506 can include an application to implement an analytics engine for insight generation. The credit score platform 300 can enable financial institution or counterparty onboarding to the distributed ledger network. The credit score platform 300 can provide on chain payment protocol and lifecycle along with the bid and list matching engine. The credit score platform 300 can include applications for fraud prevention, AML services and payment integration. The credit score platform 300 can provide data analytics and marketing insights. The credit score platform 300 can include a notification engine to transmit notifications and credit alerts by way of a channel unit 502. The micro-services unit 506 can include applications for recall and repair management. The credit score platform 300 can include services or dispute resolutions along with APIs. The credit score platform 300 can include integration middleware 512 for onboarding of third party data. The integration middleware 512 can provide dispute resolution services, creditor APIs, credit event APIs, debtor APIs, financing APIs, and entity onboarding. The credit score platform 300 can provide loan management, credit score updates, debtor confirmation, quality checks, and so on.

The credit score platform 300 can provide a credit history registry along with the loan and insurance management system. The credit score platform 300 can validate user devices by way of a channel unit 502 to automatically implement debtor registration and credit event consolidation. The credit score platform 300 can process loan applications and insurance applications. The credit score platform 300 can enable self registration using IoT devices. The credit score platform 300 can provide consolidated credit history record APIs, enhanced debtor history analytics, credit rescoring APIs, loan application integration, insurance application integration, and so on. The credit score platform 300 can provide debtor identification, creditor registration, insurance coverage, lean management, and so on.

The credit score platform 300 can provide a marketplace capability whereby a debtor and the creditor transact in a peer to peer marketplace to ensure the debtor gets a certain condition based on its credit history, and that the creditor received payment. The credit history record can identify debtor history and creditor reports. An entity can report credit events that can be reviewed during the loan process. This can provide the ability to build a centralized repository of credit data. This can provide accurate information regarding the credit value for financing purposes of considering conditions, interest terms, and so on. The credit score platform 300 can record debtor information to allow a third party to digitally record relevant data on the basis of an event directly to the distributed ledger. This can provide increased visibility of vital credit information to debtors and creditors. The distributed ledger can automatically notify a debtor by way of the distributed ledger.

Some loan frameworks can lack trusted agreements between a creditor and a debtor in a safe and secure environment. Private creditors and debtors may not engage in a formal contractual agreement for the loan arrangement which results in some degree of uncertainty regarding the transaction. It can be difficult to obtain a complete history of a debtor to understand their creditworthiness. There may be no guarantee of a secure financial transaction. The credit score platform 300 can provide an improved solution and can include smart contracts to govern the terms of an agreement in a safe and secure manner, a centralized credit history registry of debtors and creditors to match specific needs using the distributed ledger, and an immutable record of the credit history, for example.

The credit score platform 300 can provide a centralized loan repository to facilitate a peer-to-peer marketplace. A centralized loan repository based on a dynamic set of identification numbers may provide a more detailed history across borders. For example, social insurance number and social security number for an individual can be linked by a set of identifiers. In addition, it can provide multiple stakeholders with vital information to assess value, conditions and provide value-added services. The credit score platform 300 can also be used for insurance or financing purposes. The credit score platform 300 can create a peer-to-peer marketplace using distributed ledger and smart contract technology to enable a debtor and creditor to enter into digital contractual relationships that can be secured with collateral other property.

The credit score platform 300 can provide a peer to peer loan marketplace which can allow debtors and creditors to conduct transactions in a safe and secure manner. The credit score platform 300 can provide a peer-to-peer marketplace to expand opportunities and enhance the client experience. The approach can be focused on a shift of client volume towards the private sale channel, as opposed to more traditional lenders. The use of a distributed ledger may provide an infrastructure to facilitate loan agreements within a peer to peer network.

Loan transactions can have a reliance on third party information. If you are looking to lend money and you want to know the history of the debtor then you need to rely on third parties. Companies can collect information but there can be a lack of timely information. This information reported to known systems may not be instantaneous. Known approaches may have siloed information. There can be an absence of a centralized repository which can also hold other information related to the debtor. The credit score platform 300 can enable transactions to be conducted in a safe and secure manner to mitigate fraud.

Embodiments can provide an efficient system which reduces fraud, mediation fees, does not need a third party to act as trusted agent and allows loan transaction to take place much faster. By automating the capturing of information from the various ecosystems, the credit score platform 300 can remove the reliance on third parties to maintain the data. For example once the car servicing is performed, the credit score platform 300 can integrate with a device in the car dashboard to update the ledger to keep the servicing history up to date. The credit score platform 300 can facilitate finance for consumers, lenders and other third parties.

The credit score platform 300 can include a legal unit 508 to generate secure legally binding peer-to-peer contracts for the loan arrangement including repayment. The credit score platform 300 can include a channel unit 502 to generate an interface application with inventory (creditors or debtors) matched to client search requests. The channel unit 502 can interact with the legal unit 508 to create binding legal agreements. The micro-services unit 506 can enable safe and secure peer-to-peer transactions using financial systems. The credit score platform 300 can integrate with payment and backend servers. In some embodiments, the credit score platform 300 can record blocks for transactions and payments.

The credit score platform 300 can implement the following example process. The debtor or creditor generates a bid or offer and posts loan inventory or loan requests to a Loan Repository. The posting can contain key information about the creditor or debtor, loan offer, and so on. The debtor or creditor reviews inventory and the credit score platform 300 can provide the ability for the debtor or creditor to ‘shop’ and ‘add to cart’ loan postings for review. The creditor can have access to the credit history data record. The creditor shops and bids on the contract or offer. The credit score platform 300 can provide the ability for the creditor to ‘shop’ and ‘add to cart’ loan postings for review and bidding, as appropriate. The creditor accepts or rejects bids. The credit score platform 300 can provide the debtor with the ability to accept, reject or counter bids from the creditor. The creditor and debtor accept the contract. The credit score platform 300 can provide the ability to finalize and ‘seal’ bids to bind the contract terms and conditions. The creditor and debtor can send payment which can be held in escrow. Payments may be sent and held in escrow to finalize a sale in person. The credit score platform 300 can release funds in escrow to the debtor.

The legal unit 508 can manage smart contracts. Smart contracts can include code for different provisions such as: creditor and debtor Information (e.g. Name and License ID); credit Information (e.g. history information); Legal Terms and Conditions (e.g. terms that govern the agreement); Payment Terms (e.g. agreed to purchase payments and interest); Acknowledgement, and so on. The credit score platform 300 can provide the ability for: a creditor and debtor to create/modify/delete a contract; a creditor and debtor to review and bid on multiple contracts; a creditor and debtor to reject/accept bid(s); an audit of the entire transaction history, and so on.

The credit score platform 300 can record credit information with global, national, or regional scope using the set of identifiers. The credit score platform 300 can integrate with government systems, financial institution platforms, credit centres, law enforcement agencies, and so on.

The credit score platform 300 may be a distributed and decentralized ledger platform, providing trusted and permissioned access to an electronic loan Marketplace. The credit score platform 300 facilitates the loan transactions with offers matching, buy-sell operations through an event driven architecture, multi-signature transactions and smart contracts.

As noted, the may be used by the credit score platform 300 to build a centralized repository to facilitate P2P transactions for loans. The credit score platform 300 may be a distributed and decentralized ledger platform implemented using blockchain technology.

The credit score platform 300 can provide a distributed solution with a decentralized, peer-to-peer, secured network, providing ledger nodes to the trading partners banks (issuing, advising, confirming etc.) in a closed loop, permissioned environment. The credit score platform 300 can provide business domain services with distributed applications leveraging Event Driven designs and providing clear separation of concerns between business logic and technology concerns (security, logging, etc.), to control application complexity and to facilitate ongoing maintainability. The credit score platform 300 can provide modularized distributed applications that allow explicit composition of the contracts operations. They can provide a delineation between past events (transactions) and future events (contracts). The credit score platform 300 can provide data privacy and methods for securing data and ensure cryptographic protection across network participants. This can guarantee that each party's data is read and write-protected from other network participants, so they will not a gain competitive advantage and for regulatory purposes. The credit score platform 300 can provide data integrity with the ability to restore ledger data to the last known good, in case of ledger corruption. The credit score platform 300 can have the ability to identify corrupted or fraudulent data records in real time and eliminate them from the ledger. The credit score platform 300 can have the ability to identify double spend attacks in the ledger and contain them accordingly.

The credit score platform 300 can provide permission management for participants to differentiate between various parties/node roles in the network. The credit score platform 300 can provide resiliency with a fault tolerant platform, providing the ability to identify, efficiently recover from failures and reconstruct the system state from the past events. The credit score platform 300 can provide the ability to calculate the application's previous state, without impacting the platform performance and scalability. A node can recover from deadlocks, situations where it cannot accept requests, or if it times out. If requests arrive at a failed component, then the credit score platform 300 can ensure the requests continue to be processed, without being halted or delayed.

The credit score platform 300 can provide concurrency with the ability to handle concurrent process transactions without conflicts. The credit score platform 300 can provide reliability with timeouts and retries: If retries are implemented, then the credit score platform 300 can ensure that the same transaction is not processed/transmitted twice in the ledger. A timeout can hide the fact that the transaction was processed, but no ACK/NACK was sent back to the sender, for example. The credit score platform 300 can provide scalability such that the credit score platform 300 scales up or down under load, responding to various request rates. The credit score platform 300 can keep network traffic within limits, to avoid higher network load and impact on performance (especially in the polling for payment status case). The credit score platform 300 can provide change management to implement effective change and upgrade management of the ledger and contracts data, to facilitate the backward and forward compatibility. The credit score platform 300 can provide real-time monitoring of the entire ledger, to ensure high availability, and ability to react and prevent system down-times.

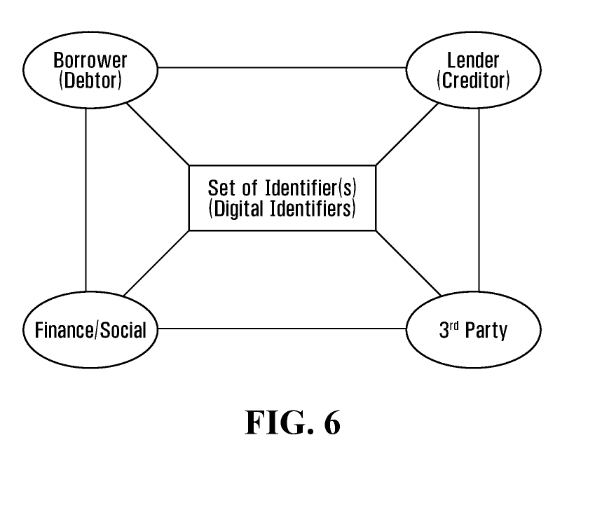

FIG. 6 is a diagram of entities interacting with a set of identifiers for an individual. The set of identifiers can provide a dynamic digital identity for an individual or organization. The set of identifiers can include multiple identifiers that can be used to indicate the individual or organization. The set of identifiers can include identifiers from different geographic locations. For example, identifier A can identify a first individual in country A, an identifier B can identify the first individual in country B, an identifier C can identify the first individual in country C. The set of identifiers identifier A, identifier B, and identifier C can be used to aggregate credit related data for the first individual across the different countries. For example a financial institution in country B may have data linked to identifier B that can be provided to credit risk platform 300. As another example, a retailer in country C may have data linked to identifier see that can be provided to credit risk platform 300. The set of identifiers for the first individual can be used to aggregate the data from different countries.

The set of identifiers can include identifiers for different types of sources. For example, identifier D can identify the first individual on social network platform D and identifier E can identify the first individual on social network platform E. The set of identifiers for the individual can include both identifier D and identifier E in order to aggregate data from social network platform D and social network platform E. As another example, identifier F can be a driver's license number for the first individual and identifier G can be a social insurance number for the first individual. The set of identifiers for the first individual can include identifier F and identifier G to aggregate data from disparate data sets. The set of identifiers can also include a universal identifier that can be assigned by platform 300 to uniquely identify the first individual.

The set of identifiers can be used by different stakeholders of the platform 300 including the debtor, the creditor, financial institutions, social networks, retailers, and other third parties. A first stakeholder may provide data about an individual to platform 300 using an identifier from the set of identifiers for the individual and a second stakeholder may access data about the individual from platform 300 using another identifier from the set of identifiers for the individual. Additional identifiers can be added to the set of identifiers to enable platform 300 to collect and aggregate additional data when generating the credit history record for an individual. Identifiers can be removed from the set of identifiers to enable platform to remove data when generating the credit history record for an individual. Adding and removing identifiers from the set of identifiers and showing the resulting credit scores can indicate the impact of the additional or removed identifiers to the calculation of the credit score. A lender may have one identifier for an individual which may result in a limited set of credit data. However, platform 300 can use the identifier to generate a set of identifiers for the individual which may result in an expanded set of credit data.

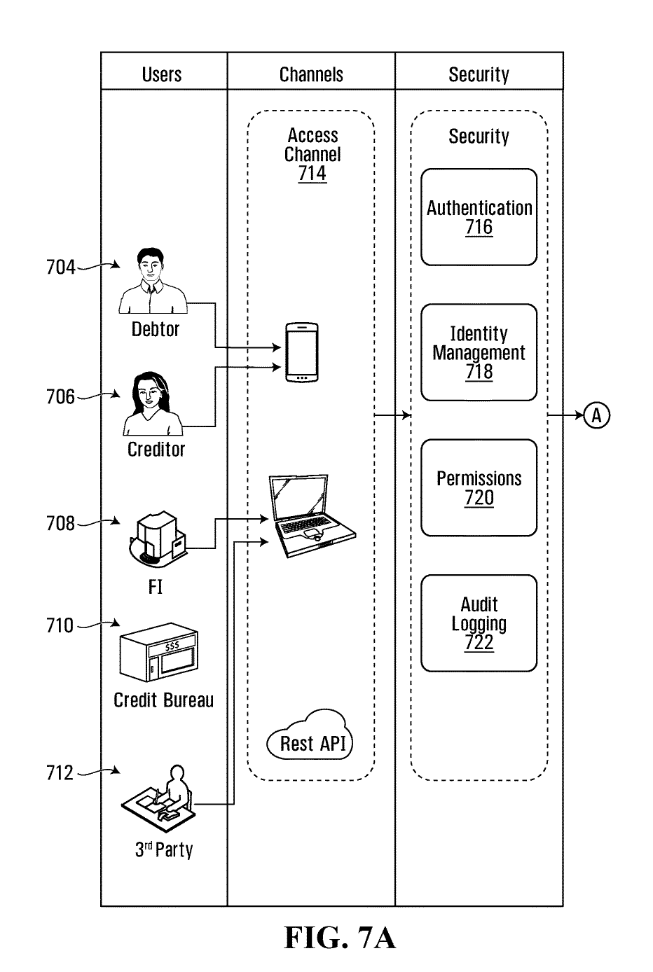

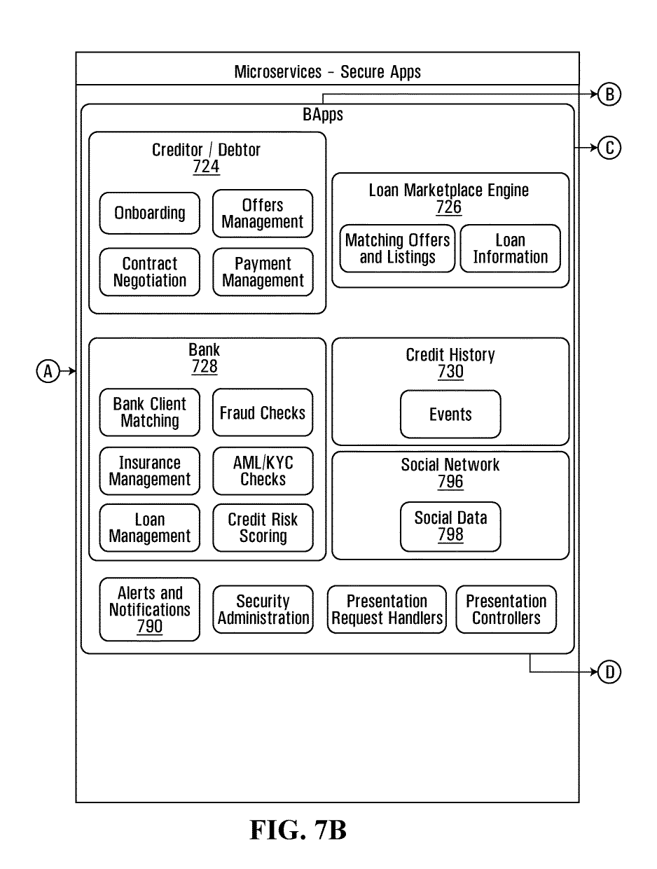

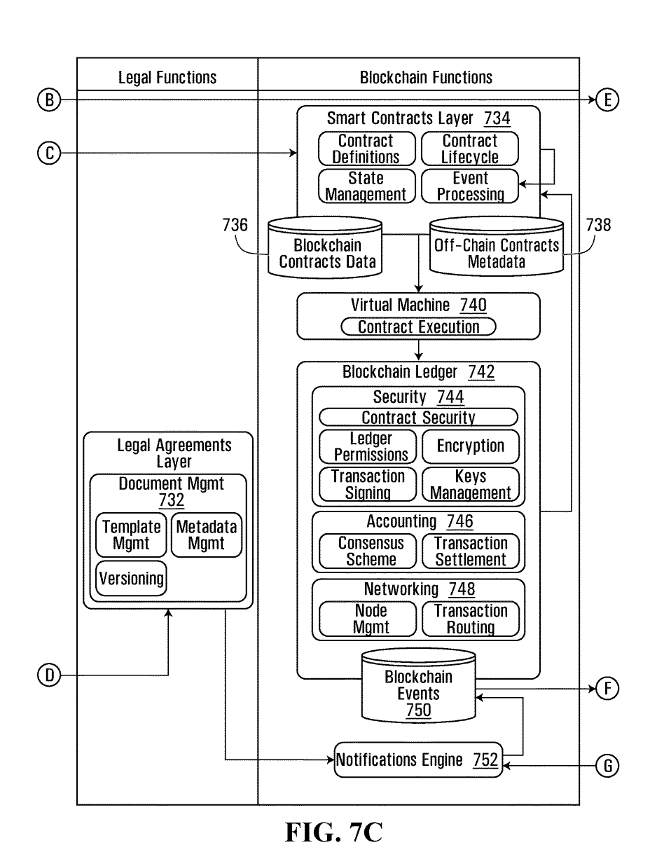

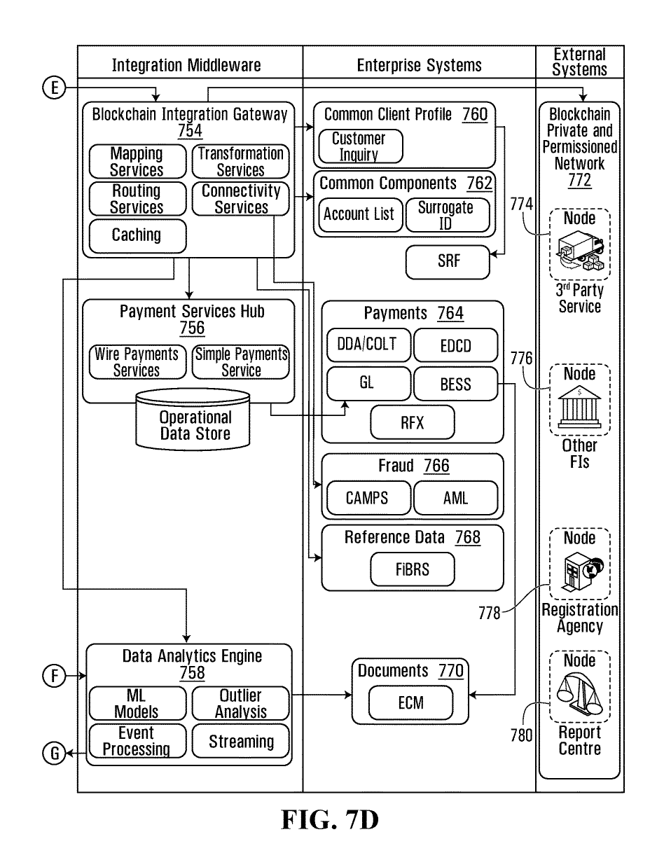

FIGS. 7A, 7B, 7C, and 7D provide a system context diagram according to some embodiments. The credit score platform 300 connects to computing devices debtor device 704, creditor device 706, financial institution device 708, credit bureau device 710, third party device 712 by way of channel access connections 714 to receive data for the distributed ledger. The credit score platform 300 receives and verifies one or more provided identifiers. The debtor device 704, creditor device 706, financial institution device 708, credit bureau device 710, third party device 712 may be able to transmit data and events related to credit worthiness to the credit score platform 300, such as loans, transactions, payment events, to record relevant events on the ledger. Channel access connections 714 can provide for contract management, electronic signatures, bid management, loan matching and insurance coverage. Applications for peer to peer marketplace interactions can be provided via online and mobile channels connections 714. Standalone APIs or SDKs can also be provided to enable integrations within third party systems in different channels of choice. These APIs can to be extensible and configurable to facilitate reusability across parties.

The credit score platform 300 can have different security tools including an authentication unit 716, an identity management unit 718 and fraud management unit 718, a permissions unit 720, and an audit logging unit 722. The security tools can manage a hierarchical model for party identities, allowing them to enroll, deactivate, and renew their credentials as required. A public and private key infrastructure can be used to maintain these identities, while being decentralized and not owned by any of the parties of the peer to peer network. The credit score platform 300 can integrate with identity providers in order to acquire additional identifiers or verify identifiers provided to the platform 300. Each party can have well defined roles, with pre-defined business authorizations to allow them access to data or operations based on permission attributes.

The credit score platform 300 has different micro-services or distributed applications such as a creditor and debtor unit 724, a loan marketplace engine 726, a bank unit 728, a credit history unit 730, and so on. The micro-services or distributed applications can provide contract management, electronic signatures, bid management, loan matching, insurance coverage, contract management, event management, and confirmation. Debtors and creditors can be provided with secure means to onboard data seamlessly into the credit score platform 300, manage their own preferences, upload loan information (e.g. images, proof of signature, warranty documents etc.), view offers and accept them, and negotiate contracts. Payments can be fulfilled through the credit score platform 300 infrastructure, converting government backed currencies to a cryptocurrency, or the payments can be realized through the usual means, such as via the Swift network leveraging bank payments services. Banks can be part of this loan marketplace, and can provide loans for the potential debtors or insurance offers. Identifying the debtors and creditors to existing clients can be performed by leveraging the infrastructure. If the creditor or debtor is not a client, then the creditor and debtor unit 724 can provide a registration interface to register the creditor or debtor on the marketplace, while executing AML and KYC verifications, for example. A modular design can allow integration with enterprise services to perform fraud checks, AML/KYC, credit risk scoring and so on for potential borrowers or an insured entity. The loan marketplace engine 726 can match automatically loan requests with potential offers, based on creditor and debtor preferences and pre-defined criteria. The role of escrow agent and clearing house can be filled by the underlying protocol based on the ledger and smart contracts, eliminating unnecessary costs, time, and third-party trust. The credit history unit 730 can receive requests for credit history records and record credit events. The credit score platform 300 includes a legal agreement layer with a document management unit 732.

The platform 300 includes an alerts and notifications unit 792 generate credit alerts to debtors in relation to credit events that have been recorded by the platform 300. This can provide transparency to the debtor in relation to credit events that have been reported about them. The credit alerts can also indicate if the credit event has a positive or negative impact on the individuals credit score. The credit alerts can indicate a net impact or an individual impact of the credit event on the credit score. The alerts and notification unit 792 can also generate alerts in relation to responses to loan requests, request to access information, request to register or verify data, and so on.

Different block chain functions include a smart contracts layer 734, block chain contracts database 736, off chain contracts metadata 738, virtual machine 740, block chain ledger 742, block chain event database 750, and notification engine 752. The block chain ledger unit 742 includes a security unit 744, an accounting unit 746, and a networking unit 748. An integration middleware layer includes a block chain integration gateway 754, a payment services hub 756, and a data analytics engine 758. The notification engine 752 can alert debtors about potential matches and to act on potential offer. Alerts can be sent via SMS, email, or in app, depending on user preferences. The block chain ledger 742 can provide contract management, electronic signatures, bid management and registration ownership. The individual or organization can be digitized by way of the digital identity generated using the set of identifiers and managed as a smart asset within the block chain ledger 742. The value is negotiated and accepted through the matching and exchange engine. The smart contracts layer 734 can capture the contractual clauses, terms and conditions, for secure definition and execution of the contract between the parties. Multi signature transactions can be provided to ensure that the loan amount is kept in escrow until the payment is finalized and all required transaction signatures are collected. Smart contracts can have related states, digital signatures, and refer to the smart asset reference data, which can be stored within block chain ledger 742. To avoid an increase of the ledger data size, the additional metadata and documentation can be stored securely off-chain, linking it through digital signatures and hashes. Transactions executed on the block chain ledger 742 can be broadcasted and accepted through the native consensus layer.

The block chain integration gateway 754 can provide for authentication management, fraud management, contract management, and electronic signatures. The block chain integration gateway 754 can leverage integration middleware to integrate with bank enterprise services, such as payments via PSH, client profile for client profile verification, matching, or for fraud prevention monitoring of the transaction legitimacy in real time.

The credit history platform 500 can provide for network management and monitoring using an administrative application to monitor each node's activity, status, and broadcasting events. Nodes can be taken offline, resynchronized if their data is out of sync with the main ledger, and broadcast events as they receive them from their peers. An access control unit can manage permissions by node and entities enrolled in the network. A data analytics engine 758 can perform data mining on the credit events data store, debtor preferences, and provide recommendations based on needs, transaction patterns and similarity with other customers, for example.

Enterprise systems include a common client profile 760, common components 762, payments unit 764, fraud unit 766, reference data 768, and documents 770. External systems include a block chain private and permission network 772. The block chain private and permission network 772 includes a node 774 for a third-party service, a node 776 for a financial institution, a node 778 for a registration agency, and a node 780 for a report centre. Accordingly, the credit score platform 300 includes security mechanisms, microservices and applications, legal tools, block chain function, integration middleware, enterprise systems, and external systems. The components of the system interact and exchange data to trigger the updates by credit score platform 300.

The credit score platform 300 generates a distributed ledger with a plurality of nodes 774, 776, 778, 780. A node 774, 776, 778, 780 can include a computing device to record blocks, for example. The distributed ledger has blocks. A block for a credit history record includes an identifier of the set of identifiers, credit or transaction data, a timestamp indicating when the block was created, a hash reference for the ledger, and so on.

The credit score platform 300 has a loan marketplace engine 726 configured to generate a loan request listing for an individual using a set of blocks from the ledger. Each block of the set of blocks has an identifier of the set of identifiers linked to the individual. The credit history record can have an initial block of a user registration, attributes, and permission attributes for the credit history record.

The debtor and creditor application 724 is configured to: receive a bid for the loan listing from a creditor, transmit a notification of the bid to a debtor, receive an acceptance of the bid from the debtor, and so on. The smart contracts middleware layer 734 is configured to generate a smart contract for the loan listing, the smart contract including a debtor electronic signature, a creditor electronic signature, and transaction terms. The integration middleware layer 754 is configured to determine that the transaction terms are satisfied and release payment, and record another block on the distributed ledger for the transaction, the other block comprising an identifier from the same set of identifiers, debtor identification, creditor identification, and the smart contract.

The security layer can be configured to verify the debtor by receiving debtor credentials prior to transmitting the notification, and verify the creditor by receiving creditor credentials and providing access to the credit history record. The security layer is configured to verify the creditor by receiving credentials and compare the creditor credentials to the attributes. The security layer is configured to verify the debtor by receiving debtor credentials, compare the debtor credentials to the permission attributes, and provide access to the credit history record.

The integration gateway 754 is configured to receive a user registration request, verify the registration request, and generate an initial block for the credit history record. The initial block can include registration details, attributes, permission attributes for the record, and one or more identifiers from the set of identifiers. The initial block can include the universal identifier that can be linked to each identifier of the set of identifiers for the individual.

The credit history application 730 can be configured to receive a credit event identifying the identifier of the set of identifiers and generate an additional block for the credit history record. The additional block can include credit event attributes and an identifier of the set of identifiers. The credit history history application 730 can be configured to receive different types of credit events.

The debtor and creditor application 724 can be configured to receive a registration request, verify the registration request, and generate an additional block for the credit history record, the additional block comprising attributes, and an identifier of the set of identifiers.

The debtor and creditor application 724 can be configured to receive a credit risk request for the debtor, receive or compute a credit score for the debtor, and generate an additional block for the credit history record, the additional block comprising attributes, the credit score, and the universal identifier or another identifier of the set of identifiers. The loan marketplace engine 726 is configured to receive a loan search request with a set of parameters and identify loan offers, creditors, or debtors based on the search request by comparing the set of parameters to the credit data. Examples of credit data include retailer data that can be used to generate insights regarding one or more individuals or organizations.

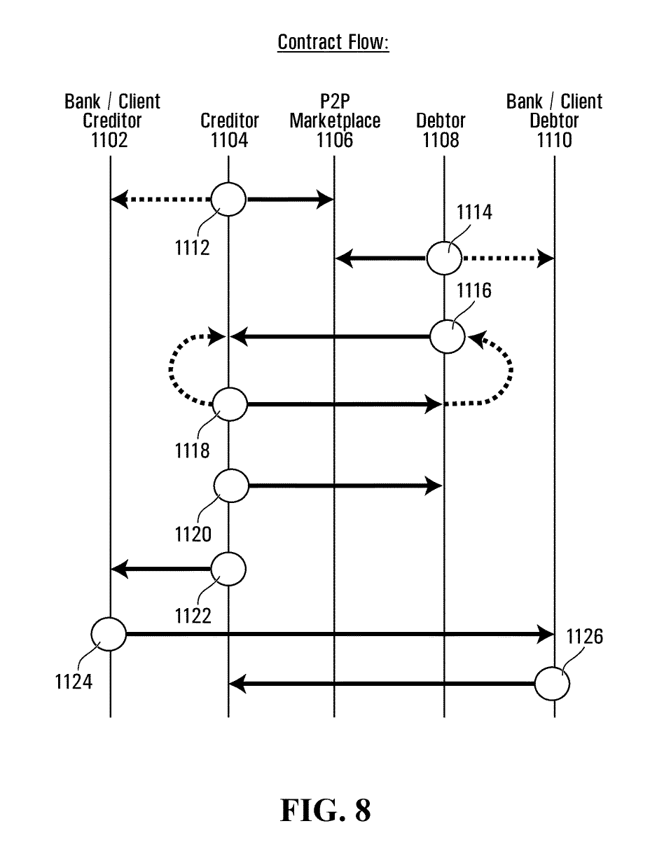

FIG. 8 is a workflow diagram of smart contract generation. The workflow includes a bank client creditor 1102, a creditor 1104, a peer to peer marketplace 1106, a debtor 1108, and a bank client debtor 1110. At 1112, a creditor 1104 creates a loan listing and contract and posts the inventory record to the peer to peer marketplace 1106. The loan listing or record can be linked to a client profile. The loan listing or record can include an identifier, description, transaction terms, and so on. At 1114, the debtor 1108 reviews loan listings or records and selects a loan listing or record to review. The selection can be linked to a client profile. Multiple loan listings can be retained in a card for future viewing. At 1116, the debtor 1108 sends a notification to the creditor 1104 to either ask a question, bid, counterfeit, or so on. At 1118, the creditor 1104 receives a debtor notification and can respond by accepting or rejecting the bid, counter bid, responding to questions, and so on. At 1120, the debtor 1108 and the creditor 1104 continue to bid until an offer is accepted to finalize the transaction. Notification is sent congratulating the creditor 1104 and the debtor 1108 on a successful transaction and can provide the following information as an acknowledgement or confirmation: a signature, terms and conditions governing the transaction. This can include legal terms and conditions, pickup information, electronic signatures, escrow fund directions, and so on. At 1122, the bank client debtor 1110 confirms funds are available and are to be held in escrow until the pickup date. Notification is sent to the creditor 1104 the funds are held in escrow until the loan date. At 1124, funds of the bank client debtor 1110 are released to the bank client creditor 1102 on the loan date. Notification is sent to confirm the release of the escrow funds prior to the release of the funds.

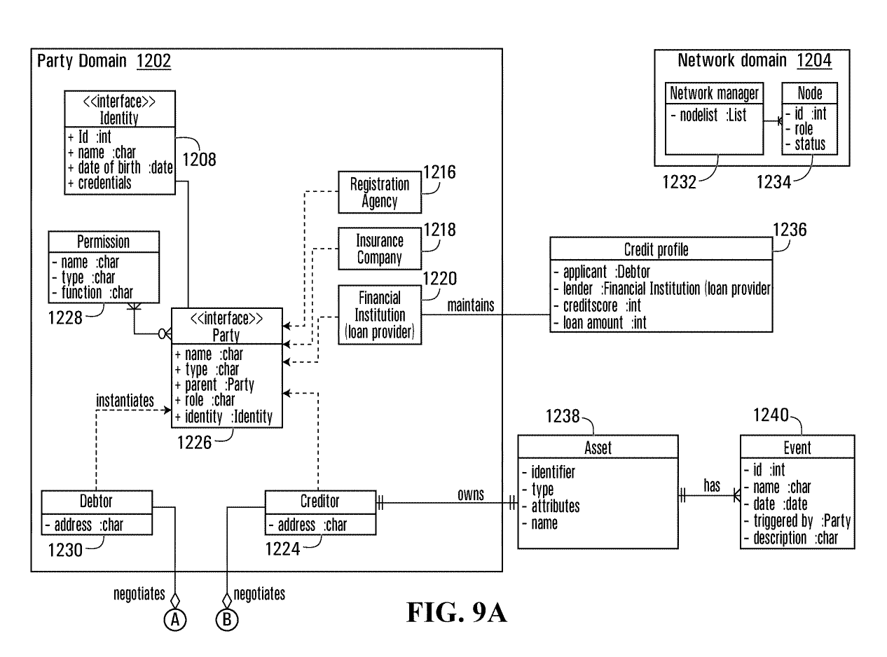

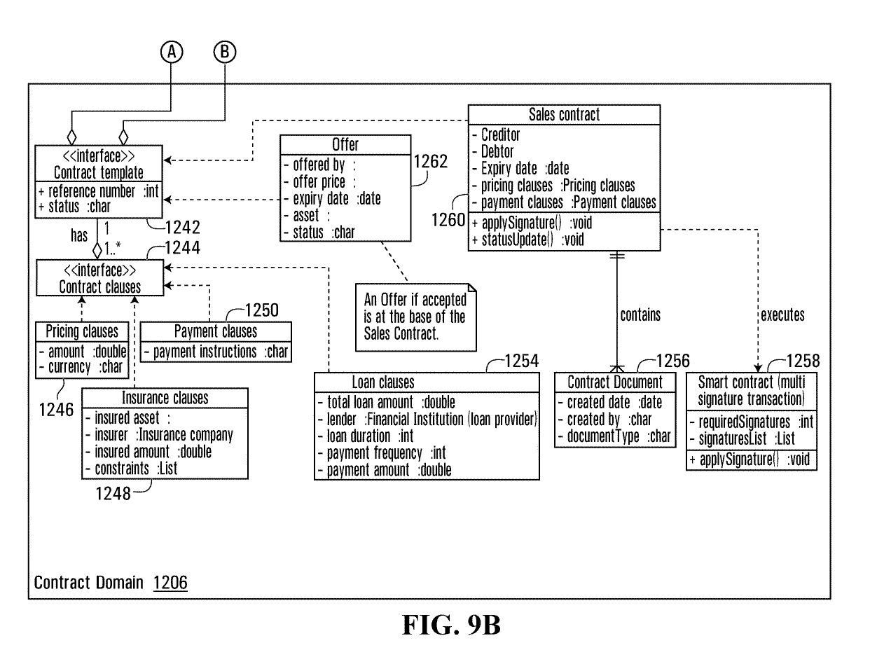

FIGS. 9A and 9B are data model diagrams according to some embodiments The data model can include a party domain 1202, a network domain 1204, and a contract domain 1206. The network domain 1204 can include a network manager object 1232 and a node object 1234.

The party domain 1202 can include a party object 1226 with example data fields including name, type, parent, role, identity, and so on. The party domain 1202 can include a registration agency object 1216, an insurance company object 1218, a financial institution or loan provider object 1220, a creditor owner object 1224, or a debtor object 1230 can instantiate a party object 1226. An identity object 1208 can include an identifier, name, date of birth, identifiers, and credentials. An identity object 1208 can be linked to a party object 1226. An identity object 1208 can indicate one or more identifiers of the set of identifiers. An identity object 1208 can include an identifier type. An identity object 1208 can be linked to a geographic location or an issuer. A permission object 1228 can include a name, type, function, and so on. A financial institution or loan provider object 1220 maintains a credit profile object 1236. A credit profile object 1236 can include an applicant or debtor, a lender or financial institution, a credit score, a loan amount, and so on. A creditor object 1224 can own an asset object 1238 such as a loan asset. The asset object 1238 can have one or more attributes. An asset object 1238 has an event object 1240. An event object 1240 can have an identifier, name, date, triggered by party, description, and so on. An event object 1240 can be used for a credit event.

The contract domain 1206 can include a contract template object 1242. A debtor object 1230 negotiates a contract template object 1242 with a creditor object 1224. A sales contract object 1260 and an offer object 1262 instantiate a contract template object 1242. A sales contract object 1260 can include a creditor, debtor, expiry date, pricing clauses, payment clauses, digital signature, status, and so on. An offer object 1262 can include an offer by creditor, offer amount, expiry date, asset identifier, status, and so on. A contract template object 1242 has one or more contract clause objects 1244. Contract clause objects 1244 can link to pricing clause objects 1246, insurance clause objects 1248, payment clause objects 1250, warranty clause objects 1252, loan clause objects 1254, and so on. Pricing clause objects 1246 can include an amount, currency, and so on. Insurance clause objects 1248 can include an insured asset identifier, ensure, insured amount, constraints, and so on. Payment clause objects 1250 can include payment instructions. Warranty clause objects 1252 can include type, asset, conditions, duration, and so on. Loan clause objects at 1254 can include total loan amount, lender, loan duration, payment frequency, payment amount, and so on. A contract document object 1256 can link to a sales contract object 1260. A contract document object 1256 can include a created date, created by, document type, and so on. A sales contract object 1260 can execute a smart contract object 1258 with multi-signatures. A smart contract object 1258 can include a list of required signatures and actual electronic signatures.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Various example embodiments are described herein. Although each embodiment represents a single combination of inventive elements, all possible combinations of the disclosed elements include the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A system for credit and digital identity records comprising:
a distributed ledger of a plurality of nodes, each node including at least a computing device, and the distributed ledger having a plurality of blocks, each block comprising identification data linked to a set of identifiers for an individual, transaction data, a timestamp indicating when the block was created, and a hash reference for the distributed ledger;
a credit history application configured to:
register an individual corresponding to a first set of identifiers;
record a set of blocks of the plurality blocks on the distributed ledger, each block of the set of blocks having an identifier of the first set of identifiers, the set of blocks including an initial block for the individual registration, the initial block comprising attributes for the individual, and permission attributes;
receive notification of a credit event for the individual, the notification having an identifier of the first set of identifiers;
record an additional block on the distributed ledger, the additional block having the identifier of the first set of identifiers and credit event attributes;
generate the credit history record using the first set of identifiers, the credit history record comprising a credit score, the set of blocks and the additional block, each block of the credit history records having an identifier of the first set of identifiers; and
transmit the credit history record to an interface, enterprise system or external system.

2. The system of claim 1 further comprising:
a digital identity application configured to:
assign a universal identifier to the individual;
record an additional set of blocks of the plurality blocks on the distributed ledger, each block of the additional set of blocks comprising the universal identifier and a different identifier of the first set of identifiers; and
generate a digital identity for the individual using the additional set of blocks and the universal identifier;
wherein the credit history application is configured to generate the credit history record using the digital identity to construct the set of identifiers.

3. The system of claim 1 wherein the credit history application is configured to calculate a change in the credit score based on the credit event.

4. The system of claim 1 wherein the credit history application is configured to determine one or more credit actions in response to the credit event using a smart contract related to the credit event and the individual, the smart contract including an electronic signature and transaction terms.

5. The system of claim 4 wherein the notification for the credit event indicates a violation of the smart contract.

6. The system of claim 1 further comprising a smart contract middleware application configured to detect violation of a term of a smart contract linked to the identifier as the credit event and trigger the notification of the credit event in response, the smart contract including an electronic signature and transaction terms.

7. The system of claim 1 further comprising a security unit configured to receive a registration request to register the individual from a registration system, and verify the registration system prior to registration of the individual.

8. The system of claim 1 further comprising a security unit configured to verify the interface, the enterprise system or the external system using the permission attributes before providing access to the credit history record.

9. The system of claim 1 further comprising a security unit configured to verify credit event for the individual prior to recording the additional block.

10. The system of claim 1 further comprising a credit marketplace engine configured to generate a listing of loan offers for the individual based on the credit history record, each loan offer indicating a creditor and loan terms, receive a selected loan offer indicating a selected creditor and selected loan terms, generate a smart contract with the selected loan terms, and record a new block on the distributed ledger, the new block having the smart contract, the identifier and the selected creditor, the smart contract being linked to an identifier of the set of identifiers and the selected creditor, the smart contract having an electronic signature and transaction terms.

11. The system of claim 1 further comprising further comprising a credit marketplace engine configured to receive a loan request for the individual and generate a listing of loan offers for the individual based on the credit history record, each loan offer indicating a creditor and loan terms.

12. The system of claim 1 further comprising a creditor and debtor application to transmit the credit history record to a creditor, receive a bid for a loan for the individual from the creditor, transmit a notification of the bid to the individual; and receive an acceptance of the bid from the individual, the bid indicating transaction terms.

13. The system of claim 12 further comprising a smart contract middleware application configured to generate a smart contract, and record a new block on the distributed ledger, the new block having the smart contract, the smart contract including an electronic debtor signature, an electronic creditor signature, the transaction terms, and an identifier of the set of identifiers.

14. The system of claim 1 further comprising an integration middleware layer configured to: determine that the transaction terms are satisfied; trigger notification of the credit event based on the determination; and record another block on the distributed ledger for the loan, the other block comprising the identifier of the set of identifiers and creditor identification.

15. The system of claim 1 further comprising an integration middleware layer configured to: receive payment notification for the loan; trigger notification of the credit event based on the payment notification.

16. The system of claim 2 further comprising an integration middleware layer configured to receive a debtor registration request for the individual, the debtor registration request indicating individual; verify the debtor registration request; trigger generation of the universal identifier by the digital identity application, and generate an initial block for the credit history record, the initial block indicating the universal identifier and debtor attributes.

17. The system of claim 1 further comprising an alert and notification unit configured to generate a credit alert for the individual indicating the credit event and transmit the credit alert to the individual using the first set of identifiers, wherein the credit history application is configured to determine an impact of the credit event on the credit history record of the individual.

18. The system of claim 1 wherein the credit history application is configured to compute a credit score based on the credit history record of the individual and generate a credit score notification indicating the credit score and the credit event.

19. A system for credit and digital identity records comprising:
a distributed ledger of a plurality of nodes, each node including at least a computing device, and the distributed ledger having a plurality of blocks, each block comprising identification data linked to a set of identifiers for an individual, transaction data, a timestamp indicating when the block was created, and a hash reference for the distributed ledger;
a credit marketplace engine configured to generate a listing of loan offers for an individual based on a credit history record comprising a set of blocks of the plurality blocks, each block of the set of blocks having an identifier of the set of identifiers, each loan offer indicating a creditor and loan terms;
a creditor and debtor application configured to:
receive a selected loan offer indicating a selected creditor and selected loan terms;
transmit a notification of the selected loan offer to the creditor;
receive an acceptance of the selected loan offer from the creditor;
a smart contracts middleware layer configured to generate a smart contract with the selected loan terms, the smart contract being linked to an identifier of the set of identifiers and the selected creditor, the smart contract having an electronic signature and transaction terms; and
an integration middleware layer configured to:
record a new block on the distributed ledger, the new block having the smart contract, the identifier and the selected creditor.

20. A computer-implemented system for maintaining credit and digital identity records, the system comprising:
a plurality of nodes, each node including at least a computing device and being configured to maintain and update a distributed ledger having a plurality of blocks; each block comprising identification data transaction data, a timestamp indicating when the block was created, a hash reference for the blockchain;
at least one processor configured to generate a credit record comprising a first set of blocks of the plurality blocks, each block of the first set of blocks comprising identification that maps to a digital identity record, the digital identity record comprising a second set of blocks of the plurality blocks, each block of the second set of blocks linked to a set of identifiers for an individual.
